(19) United States
(12) Patent Application Publication
(10) Pub. No.: US 2004/0195717 A1
(43) Pub. Date: Oct. 7, 2004

(54) Method and apparatus for forming fiber aggregate

(76) Inventors: Mitsunori Kataoka, Osaka (JP); Atsushi Suzuki, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/488,287

(22) PCT Filed: Aug. 26, 2002
(86) PCT No.: PCT/JP02/08571

(30) Foreign Application Priority Data
Sep. 3, 2001 (JP) 2001-265778

(51) Int. Cl. B29C 31/00

(52) U.S. Cl. 264/102; 264/319; 425/508; 425/504; 425/388

(57) ABSTRACT

A method for molding the fiber aggregate comprising placing divided members of a mold obtained by dividing the mold having gas permeability into the plurality of members in a developed state, filling cavities of the divided members of the mold in the developed state with the fiber aggregate wherein binder fibers having a lower melting point than that of crimped synthetic staple fibers are dispersed and mixed in matrix fibers composed of the crimped synthetic staple fibers, respectively, uniting the divided members of the mold in the developed state, uniting each divided and filled fiber aggregate, heating the united fiber aggregate, melting or softening the binder fibers, fusing the melted or softened binder fibers to the matrix fibers at their crossing points, then cooling and solidifying the melted or softened binder fibers and providing a molded product and an apparatus therefor.

### TECHNICAL FIELD

The present invention relates to a method for molding a fiber aggregate comprising filling the interior of a gas-permeable mold with the fiber aggregate in which binder fibers having a lower melting point than that of crimped staple fibers are dispersed and mixed in matrix fibers composed of the crimped synthetic staple fibers, hot-molding the filled fiber aggregate and providing a cushion structure having a three-dimensional shape and an apparatus therefor.

### BACKGROUND ART

Inexpensive urethane foams have frequently be used as cushioning materials for seats having a complicated shape such as business chairs, automobiles or aircraft. The urethane foams, however, have problems that toxic gases are produced in combustion and recycling use is difficult. Thereby, a molding material substitute therefor has earnestly been desired.

Based on the problems, attention has recently been paid to molded products obtained from a synthetic fiber aggregate as a material which substitutes for the urethane foams. The fiber aggregate comprises binder fibers having a lower melting point than that of synthetic staple fibers dispersed and mixed in the matrix composed of the synthetic staple fibers. The molded products of the fiber aggregate have been attracted attention as a material capable of solving the various problems.

The molded products thus obtained are prepared by filling the interior of a mold cavity with the opened fiber aggregate accompanied with an air carrier stream and hot-molding the fiber aggregate. In short, the molded products are formed by mutually thermally fusing fibers in the fiber aggregate at crossing points thereof with the binder fibers dispersed and mixed in the matrix fibers of the fiber aggregate. For example, JP-A 5-220278 (hereunder, JP-A means “Japanese Unexamined Patent Publication”) proposes a method for transporting the fiber aggregate as small lumps thereof together with the air carrier stream into a mold as the method for molding the fiber aggregate.

The conventional methods for molding, however, have problems described hereafter. Explanation for the problems will be made hereinafter by referring to FIGS. 16 and 17.

FIG. 16 is a schematic front sectional view and an explanatory drawing schematically exemplifying an apparatus for molding the fiber aggregate. In FIG. 16, reference symbol 1′ indicates a bottom mold member; reference symbol 2′ indicates a top mold member; reference symbol 3′ indicates a chamber; reference symbol 4′ indicates a suction apparatus; reference symbol 5′ indicates a suction duct and reference symbol F indicates the fiber aggregate, respectively. FIG. 16(a) exemplifies a method for air blowing type filling comprising blowing small lumps of the fiber aggregate into the mold cavity with an air carrier stream. FIG. 16(b) exemplifies a method for compressing the fiber aggregate blown into the mold cavity and molding the fiber aggregate into a prescribed shape.

As shown in FIG. 16, operation is initially started with filling the bottom mold member 1‘with the fiber aggregate F’ accompanied by an air carrier stream as illustrated in FIG. 16(a) in a conventional apparatus for molding. In the filling step, the interior of the chamber 3′ is kept under a negative pressure with the suction apparatus 4′ installed in the chamber 3′ to keep the base of the top mold member 2′ in a sucked state and produce the air carrier stream in the direction of arrows in the figure. The fiber aggregate F is blown from the duct 5′ into the cavity of the bottom mold member 1′ with the air carrier stream and laminated therein.

When the blowing filling of the fiber aggregate F′ is completed as mentioned above, the top mold member 2′ is set in an outer frame of the bottom mold member 1′ and the top mold member 2′ is then moved in the compressing direction of the fiber aggregate F′. Thereby, the blown fiber aggregate F is compressed. The fiber aggregate F is finally finished through heating and cooling steps and binder fibers are mutually bonded to matrix fibers at their crossing points with the binder fibers to afford a molded product C′ as exemplified in FIG. 17.

In the conventional methods, however, the following problems are caused when the mold shape is complicated. That is, as to the bottom mold member 1′ for blowing in the fiber aggregate F′, the deposit state of the fiber aggregate F′ is sufficiently responsive to a complicated shape of the bottom mold member 1′ even when the molded product C′ is of a complicated shape because the bottom mold member 1′ constitutes the blowing deposit surface of the fiber aggregate F′. As a result, in this case, the bottom mold part CB′ of the resulting molded product can sufficiently and accurately follow as the shape of the bottom mold member 1′. The fiber aggregate can be shaped into an accurate form.

When the molded product C′ is in an extremely complicated shape (that is, a design surface of the molded product C′ is a deep drawn shape having an upright wall shape, a pouched wall shape or the like in which a fin is provided or a groove is formed), there are problems as follows. A response cannot sufficiently be made to the design surface having the complicated shape. In particular, as shown in FIG. 16(b), filling of a constricted part CA′ of the top mold member 2‘with the fiber aggregate F’ is not sufficiently carried out simply by filling the bottom mold member 1‘with the fiber aggregate F’ and then clamping of the mold members according to compressing of the fiber aggregate F′ with the top mold member 2′ as shown in FIG. 17. That is, when the cavity of the top mold member 2′ has a complicated shape requiring deep drawing such as the fin or groove, the fiber aggregate F is not sufficiently packed into the part simply by clamping of the mold members (the fiber aggregate moves following the shape of the top mold member 2′ and is not filled according to the shape of the top mold member 2′). As exemplified by FIG. 17, parts of defective molding are caused in the tips CA′ of the constricted parts.

In the conventional method and apparatus for molding, the top mold member 2′ should be inserted along the outer frame of the bottom mold member 1′ after blowing the fiber aggregate F′ into the bottom mold member 1′ having the outer frame as shown in FIG. 16(b). Therefore, strict adjustment is required for positioning or clearance when the top mold member 2′ is inserted into the outer frame of the bottom mold member 1′ and positioning accuracy of mold and clearance setting of the mold are extremely difficult. Furthermore, a failure for inserting the top mold member 2′ into the bottom mold member 1′ results in problems that the mold members are damaged or broken.

The molded product C′ thus molded is covered with a skin for use; however, a hanging wire for fixing the skin onto the molded product C′ is required in this case. It is necessary to mount a metal fixture for fixing the molded product C′ per se onto the base part in the molded product C′.

In the cases, it is necessary to carry out drilling in the molded product C′ after the molding for mounting in the conventional methods. An excessive production process such as the drilling is required for the methods. Therefore, cost is increased. For the reasons, a method for molding processing of the molded product C′ with which the excessive processing process can be omitted and an apparatus therefor are earnestly desired.

### DISCLOSURE OF THE INVENTION

The present invention has been made by taking the problems described above into consideration. It is an object of the present invention to provide a method for molding the fiber aggregate which fills the mold into a desired three-dimensional shape by using the fiber aggregate comprising binder fibers having a lower melting point than that of crimped synthetic staple fibers dispersed and mixed in matrix fibers composed of the crimped synthetic staple fibers and using the melted or softened binder fibers as an adhesive material and an apparatus therefor. Furthermore, the “fiber aggregate” is sometimes called “staple fibers” in the explanation as follows.

As already mentioned in the background art, it is difficult to obtain a molded product of excellent quality having a complicated shape such as deep drawing, an upright wall, a pouched wall or a folded wall shape by the conventional mold for molding the fiber aggregate. As a result of intensive studies made on the causes, the inventors have found out that the difficulty is caused by adopting a method for “forming a cavity surrounded with mold walls, then filling the cavity with the staple fibers, clamping the mold members and hot-molding the staple fibers” adopted by the prior art.

In the present invention, the mold is initially divided into a plurality of members and the divided members of the mold are filled with the staple fibers. Even a mold having a complicated cavity shape can be returned to the plurality of divided members of the mold having a simple cavity shape by dividing the mold. That is, the cavity shape of the mold can be returned from the complicated shape to the simple shape. Each part of the staple fibers which fill the cavity without defective filling is united and formed into a desired three-dimensional shape. Thus, a molded product having a complicated shape, for example a deep drawing shape, an upright wall shape, a pouched wall shape or a folded wall shape can readily be obtained from the united staple fibers.

In order to obtain the molded product having excellent quality, it is necessary that properties of the molded product such as degree of stiffness, repulsive performances or resistance to loss of bulkiness are excellent. As a result, in the present invention, it is preferable that the filling density of staple fibers, contents of staple fibers which fill the cavity of the mold, addition of functional materials or the like are freely regulated.

First, with regard to the regulation of the filling density of staple fibers, as mentioned in the present invention, staple fibers are previously packed into a prescribed site of the mold cavity at a prescribed density and the staple fibers in the divided parts of the mold are united in any step before heating, during heating and just after heating of the staple fibers to carry out clamping of the mold members. The regulation of the filling density of the staple fibers can be realized by compressing the united staple fibers at least once by clamping of the mold members in any step before heating, during heating, after heating and during cooling. In order to ensure the dimensional stability of the staple fibers after molding, it is preferable that compression of the staple fibers by clamping of the mold members is carried out by performing compressing operation for absorbing a dimensional change at least once in any step during heating, after heating and during cooling. Since tear strength or the like in the united surface are weakened in uniting the staple fibers, it is preferable that the united surface is previously sprayed or coated with an adhesive material or the united part of the staple fibers to be united is subjected to partial auxiliary heating to improve adhesive strength of the united surface.

In order to locally change performances of the molded product or bring out complicated performances by hybridizing materials having different performances, the present invention is characterized in that lamination or juxtaposition of the functional materials, functional agents, staple fibers composed of different kinds of materials, materials different in blending ratio of matrix fibers and binder fibers, sole heat-bonding fibers or the like in each cavity site of the divided members of the mold or spraying or coating is extremely facilitated by combination of a filling means adopting an air blowing method and/or a filling means using a robot or the like. Since the filled staple fibers can be pushed into the divided members of the mold, or lumps of the staple fibers can additionally be filled, it is extremely easy to carry out density regulation so that the bulk density of the staple fibers which fill the predetermined cavity site is a prescribed density. This is because the cavity shape is simple and a filling port for filling the cavity with the staple fibers is widely opened to simultaneously receive a plurality of transporting means in the divided members of the mold of the present invention.

The present invention has advantages in that each divided member of the mold can simultaneously be filled with the staple fibers together and the time required for the filling is thereby remarkably shortened as compared with that of the conventional method, and that the cavity shape simplified by the dividing is filled with the staple fibers and even all the corners of the cavity are well filled with the staple fibers without unevennesses to cause no defective filling.

In addition, it is necessary to form the cavity and then fill the cavity with the staple fibers according to conventional methods when there is a need of setting components for attaching various kinds of attachments or decorations to a molded product after completing the molding. Therefore, it is necessary to previously assemble the components in the formed cavity. In this case, however, the components assembled in the cavity act as obstacles so that the filling of the cavity with the staple fibers cannot sometimes be well carried out. Against this, in the present invention, an obstacle to the filling of the cavity with the staple fibers can be prevented even if the obstacle is present for dividing the mold by previously designing a method for dividing the mold in order to avoid the obstacle or carrying out mold packing in a state of no component present in the mold, setting the components during the mold packing and clamping of the mold members again.

In the present invention, when drilling tools are previously additionally installed in the divided members of the mold, necessary drilling is already carried out in a stage of uniting the divided members of the mold, for example in the case of drilling performed in a molded product in order to attach the attachments or decorations. Therefore, an excessive step such as practice of drilling again for the molded product after molding as in the conventional method can be omitted.

In the present invention, there are problems that joints of the mold are transferred to the molded product because the divided members of the mold are used. In this respect, when the mold is divided, the joints of the mold can be prevented from causing problems so much, for example by using a design surface as the reference. When the divided members of the mold are united, there is a possibility of moving the staple fibers which fill the divided members of the mold from the normal position to another in the present invention. In order to eliminate the problems, it is preferable that openings of the divided members of the mold are closed by using auxiliary mold members fulfilling the role as a lid for closing the openings and the cavities of the divided members of the mold are not opened spaces but closed spaces for making the staple fibers unmovable during movement of the divided members of the mold. However, in this case, it is necessary to remove the auxiliary mold members after completely uniting the staple fibers or just before uniting of the staple fibers. As the auxiliary mold members, a product completing hot-molding using the same material as that of staple fibers used for the molding of the present invention can be used in some cases or a heat bonding material separate from the staple fibers may be used.

In the present invention, suction apparatus for sucking air in the cavity from the back surface to be just the back side of the cavity surface for storing the staple fibers in the divided members of the mold are connected through flexible ducts or the like. It is preferable to unite the staple fibers while operating the suction apparatus. This is because air pressure (wind pressure) sucked with the suction apparatus acts on the front of the filled staple fibers and the wind pressure performs actions on pressing the staple fibers to the walls of the divided members of the mold. In addition, it is needless to say that the suction apparatus and auxiliary mold members can individually be used or used in combination in the present invention.

It is preferable that the divided members of the mold in a united or a developed state are integrally independently freely movable in the method and apparatus of the present invention. Since a state in which the divided members of the mold are filled with the staple fibers that are united can intactly be maintained by making the divided members of the mold integrally independently freely movable, for example a heating and cooling apparatus is separately installed in a hot-molding step and a plurality of united mold members in which the staple fibers are united can be stored and heat-treated at a time. Therefore, a large amount of molded products can simultaneously be produced because the heat-treating time in the hot-molding step is long even if the shortening of the molding time is rate determining. As a result, the molding time can remarkably be shortened in aspects of molding time per molded product.

In the present invention, it is preferable to pass heated air through the interior of staple fibers in the antigravity direction. This is because the staple fibers are easily deformed by heating. When the heated air is passed through the staple fibers in the gravity direction, the staple fibers are excessively deformed by the wind pressure of the heated air and own weight of the staple fibers. Therefore, the molded product becomes a distorted shape and product value is lowered even when the molded product is thus obtained. In order to eliminate unevenness of heat treatment of the molded product, it is preferable that the staple fibers are heated from both the upper and the lower sides with heated air without unevenness by turning the mold upside down while keeping the direction to pass the heated air through the fiber aggregate as the antigravity direction.

### BRIEF DESCRIPTION OF DRAWINGS

FIG. 1 is an explanatory drawing exemplified for schematically explaining an apparatus for carrying out the method for packing the staple fibers of the present invention.

FIG. 2 is an explanatory drawing (side sectional view) exemplified for schematically explaining the manner of opening the staple fibers fed in a sliver form and then filling the mold cavity with the staple fibers by an air blowing method.

FIG. 3 is an explanatory drawing for schematically explaining the divided members of the mold for closing the openings with auxiliary mold members and producing the molded product in a hot-molding step.

FIG. 4 is a side sectional view exemplified for schematically explaining a state in which the divided members of the mold after packing the mold are accompanied in the apparatus for molding the staple fibers of the present invention.

FIG. 5(a) is an explanatory drawing (side sectional view) exemplified for schematically explaining a state before compression after filling each cavity of the divided members of the mold with the staple fibers and FIG. 5(b) is an explanatory drawing (side sectional view) exemplified for schematically explaining a state after compression of the staple fibers in the interior of the divided members of the mold, respectively.

FIG. 6 is an explanatory drawing (side sectional view) exemplified for schematically explaining the molded product obtained by hot-molding the staple fibers using the clamped mold members in FIG. 5.

FIG. 6(a) is an explanatory drawing (side sectional view) exemplified for schematically explaining an embodiment for locally varying gas permeability of each site of the mold and FIG. 6(b) is an explanatory drawing (side sectional view) exemplified for schematically explaining the embodiment for locally sucking the staple fibers packed into the mold from the back side of the mold and controlling the filling density of the staple fibers, respectively.

FIG. 8 is an explanatory drawing (side sectional view) exemplified for schematically explaining the manner of laminating and filling of the divided members of the mold with the materials of different kinds in many layers.

FIG. 9 is an explanatory drawing (side sectional view) exemplified for schematically explaining various kinds of embodiments of the molded product in which the materials of different kinds are laminated in many layers by the method exemplified in FIG. 8.

FIG. 10 is en explanatory drawing (side sectional view) exemplified for schematically explaining the manner of assembling various kinds of components, attachments, supporting members or the like in the interior of the molded product.

FIG. 11 is an explanatory drawing (side sectional view) exemplified for schematically explaining various kinds of embodiments for improving the blowing properties of the staple fibers into deep drawing parts of the divided members of the mold and preventing the blown staple fibers from causing slip on the mold wall surface.

FIG. 12 is an explanatory drawing (side sectional view) exemplified for schematically explaining the manner of packing the staple fibers into the deep drawn parts of the divided members of the mold.

FIG. 13 is an explanatory drawing (side sectional view) exemplified for schematically explaining drilling in a molding process without drilling the molded product after hot-molding.

FIG. 14 is an explanatory drawing (side sectional view) exemplified for schematically explaining the method for integrally molding the skin with the staple fibers.

FIG. 15 is an explanatory drawing (side sectional view) exemplified for schematically explaining an apparatus for molding the molded product having a pouched wall shape or an upright wall shape and FIG. 15(a) is an explanatory drawing exemplified for schematically explaining the state of the mold kept in the developed state before packing the staple fibers. FIG. 15(b) is an explanatory drawing exemplified for schematically explaining the state just after packing the staple fibers and FIG. 15(c) is an explanatory drawing exemplified for schematically explaining the state during clamping of the mold members of the developed mold. FIG. 15(d) is an explanatory drawing exemplified for schematically explaining the state after completing the clamping of the mold members and FIG. 15(e1) is an explanatory drawing exemplified for schematically explaining the molded product and laminating direction according to the method for molding of the present invention. FIG. 15(e2) is an explanatory drawing exemplified for schematically explaining the molded product and laminating direction according to the conventional method for molding and FIG. 15(f) is an explanatory drawing exemplified for schematically explaining a guide means when the divided members of the mold are integrated, respectively.

FIG. 16 is a side sectional view exemplified for schematically explaining the conventional method for packing the staple fibers and an apparatus therefor.

FIG. 17 is an explanatory drawing (side sectional view) exemplified for schematically explaining the molded product hot-molded by the conventional method for packing the staple fibers and an apparatus therefor.

### EMBODIMENTS FOR CARRYING OUT THE INVENTION

The fiber aggregate (staple fibers) of the present invention is composed of matrix fibers and binder fibers dispersed and mixed in the matrix fibers. There is no reason to especially limit the material of the matrix fibers used in the present invention so far as the object of the present invention can be achieved. However, specific examples of the matrix fibers include staple fibers composed of polyethylene terephthalate, polybutylene terephthalate, polyhexamethylene terephthalate, polytetramethylene terephthalate, poly1,4-dimethylcyclohexane terephthalate, polypivalolactone, polytrimethylene terephthalate or copolyesters thereof, a mixture of the staple fibers or conjugated staple fibers composed of two or more kinds of the polymer components or the like.

The cross-sectional shape of the matrix fibers having a staple fiber shape may be herein any of a circular, a flat, a modified cross-sectional shape or a hollow shape. Crimps imparted to the synthetic staple fibers in this case are preferably actual crimps. Furthermore, the actual crimps can be obtained by a mechanical method with a crimper or the like, a method by nonuniform cooling during spinning, a method for heating side-by-side type or eccentric sheath-core conjugated fibers or the like.

On the other hand, for example polyurethane elastomer or polyester elastomer fibers can suitably be used as binder fibers. In particular, conjugated fibers in which the polymers are exposed to a part or all of the fiber surfaces can suitably be used. The conjugated fibers are provided as those of the side-by-side or eccentric sheath-core form in which a polymer composing the matrix fibers is laminated to an elastomer such as the polyurethane elastomer or polyester elastomer. The binder fibers thus formed in a suitable amount according to required performances of the product to be molded are dispersed and mixed in the matrix fibers.

Advantages in using conjugated fibers as the binder fibers are that only a binder component can be melted and mutually bonded in joining points to the matrix fibers while keeping the fibrous form because a fibrous form is left as it is and only the melting component can be melted without melting a nonmelting component composing the binder fibers when the binder fibers are used as an adhesive material for the matrix fibers. This is because the melting point difference between the melting component and the nonmelting component of the binder fibers can be increased herein and only the melting component of the binder fibers can rapidly be melted without requiring strict control of a temperature rise when hot-molding is carried out. When there is no need of utilizing the advantages, the binder fibers are not conjugated fibers and can be used by softening the binder fibers in a state without losing the fibrous shape. In this case, it is needless to say that necessity of the strict control of the hot-molding temperature arises so as not to melt the whole binder fibers and lose the fibrous form.

As mentioned above, the binder fibers contained in the fiber aggregate can be melted or softened to fuse mutual fibers composing the fiber aggregate in sites crossing with the binder fibers by heating the fiber aggregate at a temperature not lower than the melting temperature or softening temperature of the binder fibers but lower than the melting temperature of the matrix fibers. A cushion structure derived from the fiber aggregate can be hot-molded into an optional three-dimensional shape by cooling the fiber aggregate after completing the fusion of the mutual fibers and solidifying the fused parts.

The embodiments of the present invention will be detailed hereinafter by referring to the drawings.

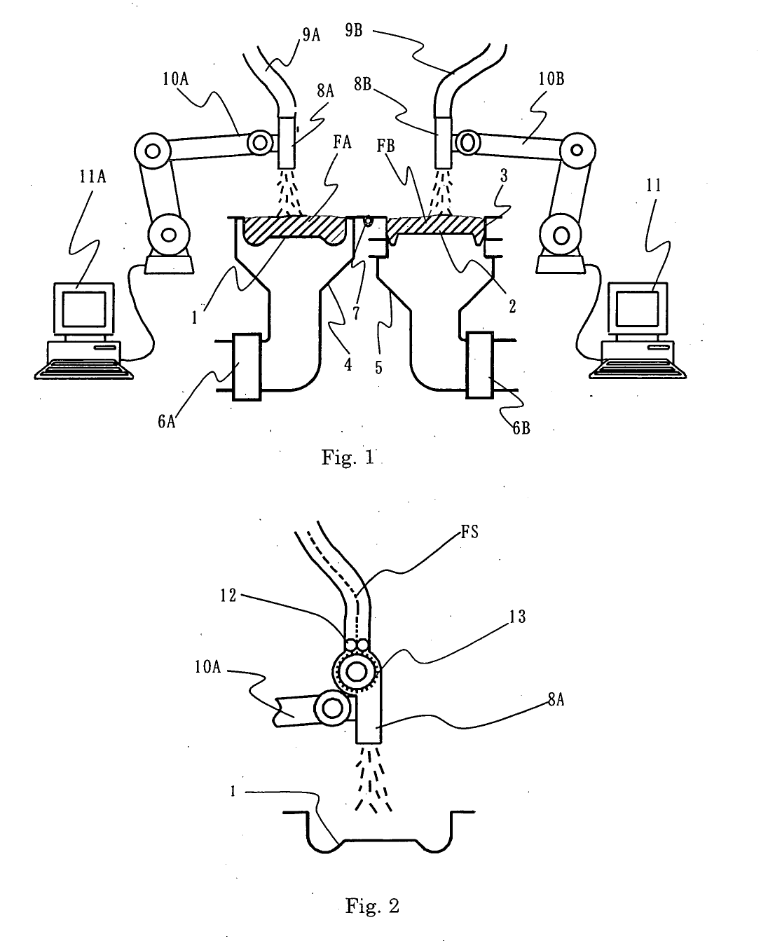

FIG. 1 is an explanatory drawing schematically exemplifying an apparatus for carrying out the method for packing the staple fibers of the present invention. In FIG. 1, reference symbols 1 and 2 indicate a right design surface mold member and a back design surface mold member divided into the upper and lower sides with the design surface as the reference, respectively. The right design surface mold member 1 and the back design surface mold member 2 compose divided members of the mold, respectively. Thus, an explanation will be made for the case of using a bisected mold which is the simplest embodiment as the divided members of the mold such as the right design surface mold member 1 and the back design surface mold member 2 hereinafter in order to avoid a complicated explanation. This is the same with the divided members of the mold divided into three or more members. It is necessary that the right design surface mold member 1 and the back design surface mold member 2 have gas permeability. The gas permeability can be formed by drilling a plurality of holes on the wall surface of the mold or can be realized by using a material such as a metal wire net woven or knitted from metal fine wires or a porous sintered metal.

As mentioned above, air can freely be made to flow through the mold wall by composing the right design surface mold member 1 and the back design surface mold member 2 of a material having gas permeability. In the present invention, filling of the cavities of the mold members 1 and 2 with the staple fibers F through a human hand, a robot hand or the like is included as an embodiment thereof. Apart from the case, carrier air streams can easily be separated from the mold wall having the air permeability by leaving only the staple fibers which fill the mold cavities when the staple fibers F are accompanied with the carrier air streams to fill the cavities of the right design surface mold member 1 and the back design surface mold member 2 with the staple fibers F.

Air streams during hot-molding (called also molding air streams) during hot-molding for heating or cooling the staple fibers F can be passed through the mold wall and easily made to flow by providing the gas-permeable mold thus described above when the cavities of the right design surface mold member 1 and the back design surface mold member 2 are filled with the staple fibers F which are then compressed to a desired filling density and then converted into the cushion material. It is needless to say that the staple fibers which fill the mold cavities per se have good gas permeability. Therefore, the molding air streams can freely be made to flow through the staple fibers which fill the mold cavities. As a result, the following excellent effects are produced. The temperature of the staple fibers can be raised in a short time without unevenness of hot-molding and a molded product of excellent quality can be obtained while shortening the molding time.

In the embodiment exemplified in FIG. 1, the bisected mold divided into the right design surface mold member 1 and the back design surface mold member 2 is exemplified as the divided members of the mold. As mentioned above, it is needless to say that mold divided into three or more members can be used. In the cases, it is necessary to use the divided members of the mold having gas permeability in which the mold is divided into a plurality of members of the mold on the basis of the design surface of the molded product and each divided member of the mold is separately filled with the staple fibers.

In the present invention, one great feature is to individually fill each cavity of the divided members of the mold, i.e. each cavity of the right design surface mold member 1 and the back design surface mold member 2 with the staple fibers FA and staple fibers FB in the example of FIG. 1. The great feature is that the right design surface mold member 1 and the back design surface mold member 2 individually separately filled with the staple fibers FA and staple fibers FB are united to form a lump F of the staple fibers FA united with the staple fibers FB. In the divided members of the mold divided into the three or more members, the united mold members for obtaining one molded product is formed by integrally combining the divided members of the mold group and clamping the mold members.

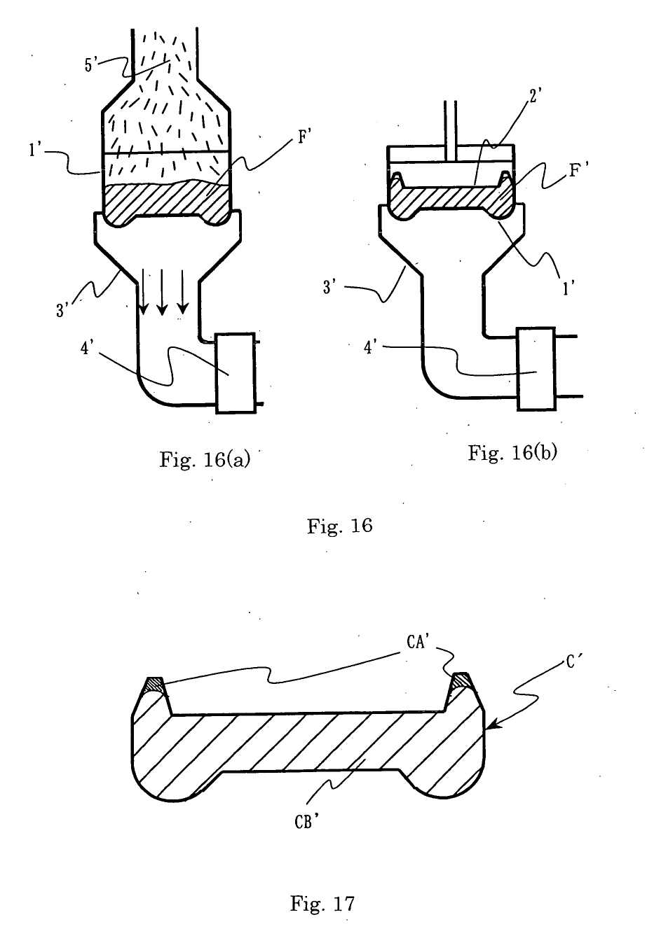

In contrast to this, in the conventional method and apparatus therefor, operation is carried out by blowing a prescribed amount of the staple fibers F′ into the cavity of the bottom mold member 1 at a time or filling the staple fibers at a time by using a human hand, a robot or the like as illustrated in FIG. 16(a), finally compressing the staple fibers F′ to a prescribed density by clamping of the mold members with the top mold member as shown in FIG. 16(b) and then converting the staple fibers F′ into a cushion material C′ in the hot-molding step.

However, the present invention is greatly different from the prior art. That is, the method and apparatus of the present invention have great features different from the prior art such that each cavity formed in the right design surface mold member 1 and the back design surface mold member 2 is filled with the staple fibers FA and staple fibers FB, respectively as shown in FIG. 1. An explanation for the point will be made in detail hereinafter.

In the present invention, as mentioned above, operation is initially started with separate filling of a cavity of the right design surface mold member 1 and a cavity of the back design surface mold member 2 with the staple fibers FA and FB. Furthermore, in the embodiment illustrated in FIG. 1, the filling of the cavity of the right design surface mold member 1 and the cavity of the back design surface mold member 2 with the staple fibers FA and FB is carried out with carrier air streams by using filling nozzles 8A and 8B (corresponding to “filling means” mentioned in the present invention), respectively. A filling means for temporarily shaping the staple fibers into a prescribed form and then packing the temporarily shaped staple fibers into the mold with a robot or a filling means for filling the staple fibers formed into a sliver state by adopting a constant rate feeding means such as a nip roller, a feed roller or a belt conveyor or the like can be used as other filling means preferably usable in the present invention. However, from aspects of automatically filling of the mold cavity with the staple fibers and shortening the filling time, it is a preferable mode of carrying out the filling with the carrier air streams by using the filling nozzles 8A and 8B as the filling means as in the case of the embodiment in FIG. 1.

Filling of the cavity of the right design surface mold member 1 and the cavity of the back design surface mold member 2 with the staple fibers is thus carried out by blowing the staple fibers FA and FB opened to the form of small lumps accompanied with the carrier air streams from blowoff ports of the filling nozzles 8A and 8B which are the filling means. In the process, it is needless to say that the blowoff ports of the filling nozzles 8A and 8B are freely movable to optional positions of the mold members 1 and 2. The blowoff ports can freely be moved to the optional positions of the mold cavities by making the blowoff ports of the filling nozzles 8A and 8B freely movable as mentioned above and even all corners of the cavities can be filled with the staple fibers without a bias even if the cavity shapes are complicated. Additional installation of heated air blowoff means for blowing off heated air on the blowoff ports of the filling nozzles 8A and 8B is also a preferable mode. This is because the filling density of the staple fibers in the cavities can be changed by softening the staple fibers which fill the mold cavities or making the staple fibers lose the elasticity with the heated air blown from the heated air bowoff means. The divided staple fibers can easily be united by partially heating the joining areas of the divided staple fibers as in the case of combining the divided staple fibers.

In addition, flexible transporting ducts 9A and 9B are connected to the filling nozzles 8A and 8B, respectively so as to assure the degree of freedom of movement thereof. Thus, since the filling nozzles 8A and 8B are connected to the flexible transporting ducts 9A and 9B, respectively, the filling nozzles 8A and 8B can freely be moved to optional positions of the mold cavities. Examples of the structure of the transporting ducts 9A and 9B assuring the degree of freedom of the movement include a duct having a bellows structure, a telescopic duct freely expanding and contracting in the front and rear directions and the like. Examples of a flexible material include a duct manufactured from a woven or a knitted fabric having airtightness or a flexible film material such as a plastic film and having flexibility.

Therefore, the staple fibers of the small lumps pneumatically transported in the transporting ducts 9A and 9B with the carrier air streams, respectively together with the carrier air streams are blown off from the filling nozzles 8A and 8B into predetermined positions of the mold to be filled. The staple fibers FA and FB are deposited on the cavity of the right design surface mold member 1 and the cavity of the back design surface mold member 2, respectively to thereby fill the mold cavities with the staple fibers.

In filling of the mold cavities with the staple fibers, it is preferable to blow the staple fibers FA and FB in the mold cavities in a state of the air suction exerted from the back surface of the filling surfaces where the staple fibers are deposited with the suction apparatus 6A and 6B. This is because the carrier air streams blown into the mold cavities can quickly be discharged by blowing the staple fibers FA and FB as mentioned above. Thereby, the staple fibers in a state of the small lumps can well be deposited or laminated into the right design surface mold member 1 and the back design surface mold member 2.

In the process, the filling is carried out while changing the position for filling by moving the filling nozzles 8A and 8B with a moving means in order to uniformly fill the mold cavities with the staple fibers. Therefore, the filling nozzles 8A and 8B are held with the moving means composed of robot arms 10A and 10B on three or more axes having a degree of freedom and the filling nozzles 8A and 8B can thereby be freely moved on the mold cavities.

The moving means composed of the robot arms 10A and 10B are herein controlled according to a program built in controlling means 11A and 11B composed of a computer, a sequencer or the like, respectively. Operation procedures predetermined according to each condition are stored in the built in program and various kinds of control are performed with controlling means 11A and 11B so as to make the moving means stay in prescribed positions for a prescribed time according to the operation procedures.

The design surface shapes of the mold members 1 and 2, moving passages of the moving means 10A and 10B of the filling nozzles 8A and 8B and, if necessary, residence time in each site are programmed herein in the controlling means 11A and 11B. Therefore, the feedback control of filling of the staple fibers FA and FB can be performed on the basis of image information incorporating a filled state (volume height of the staple fibers which fill the cavities of the divided members of the mold or the like) obtained by the filled height of the staple fibers FA and FB in the mold members 1 and 2 with a video camera or the like, suction differential pressure information about each cavity site of the divided members of the mold or the like by, for example the controlling means 11A and 11B. In the process, it is needless to say that the suction differential pressure information about each site in the mold members is obtained by measuring a change in suction pressure at the back surface of each cavity part of the mold members 1 and 2 sucked with the suction apparatus 6A and 6B using pressure detecting probes.

The example of FIG. 1 describes a mode in which each one of blowoff ports 8A and 8B of the filling nozzles is installed corresponding to the right design surface mold member 1 and the back design surface mold member 2. However, two or more blowoff ports, if necessary, can be installed. In the process, the staple fibers may be filled by installing a filling nozzle (not shown) for exclusive use in a place where filling unevenness is easily caused or the like according to the complicated shape of the mold cavities. Furthermore, a response can be made not only to the shape of the mold members but also a change in the staple fibers to be blown. That is, a plurality of filling nozzles only in a number required to blow in different kinds of staple fibers, staple fibers of different blending ratios, a thermal adhesives or a thermal adhesive material, binder fibers or the like can be installed so that the kind of the staple fibers to be blown can be changed in blowing the staple fibers in the mold cavities.

The filling nozzles for exclusive use corresponding to the material to be transported and transporting ducts for exclusive use of the filling nozzles can be used in the manner as described above and the different kinds of staple fibers, staple fibers of the different blending ratios, a thermal adhesive or a thermal adhesive material and binder fibers can be prevented from mixing together. When slight mixing of the material can be permitted, an embodiment so as to feed each material into the filling nozzles 8A and/or 8B by installing branched ducts (not shown) for individually feeding each material on the upstream side of the transporting ducts 9A and 9B while changing over the material, if necessary, can be adopted.

A predetermined place can be filled with a plurality of kinds of staple fibers and the quality or characteristics of the resulting molded product can locally be optimized by performing the procedures as mentioned above. For example, properties such as local degree of stiffness, repulsion or gas permeability of the molded product are changed simply by changing the degree of compression of the staple fibers blown in the mold cavities, whereas the degree of stiffness, repulsion, air permeability or the like can be changed even by changing the kind of staple fibers and an extremely flexible response can be made. A mode in which a functional agent blowoff means for blowing off a misty and/or a powdery functional agent is installed side by side with the filling means to carry out spraying or coating of the functional agent such as an adhesive, a hygroscopic agent, a flavoring agent or an antimicrobial agent into the staple fibers is also a preferable mode.

The amount of the staple fibers which fill each part of the mold cavities may be regulated by carrying out regulation of the residence time of filling nozzles, pressure and flow rate of carrier air streams, amount of the staple fibers accompanied with the carrier air streams and the like in each part. The feedback control of depositing or laminating conditions of the staple fibers can be performed by monitoring the conditions of the staple fibers during filling. In the process, when the length of the transporting ducts 9A and 9B mentioned above is increased, there is a fear of causing dispersion of feed rate by mutually entangling the staple fibers in the form of the small lumps during the pneumatic transportation with static electricity, a turbulent flow or the like generated during the transportation as constitution of a feeder for feeding the staple fibers into the mold cavities. Accordingly, in such a case as shown in FIG. 2, a method for feeding the staple fibers to an opening apparatus 13 provided near the filling nozzle and feeding the staple fibers from the opening apparatus 13 to the filling nozzle 8A at a constant rate without using the carrier air streams but using a pair of nip rolls may be adopted as the constant rate feeding means 12 for feeding the staple fibers FS formed into a sliver shape as a transporting means for the staple fibers. An apparatus in which opening needles for loosening the fiber lumps are implanted onto a rotating cylinder can preferably be used as the opening apparatus 13 as exemplified in FIG. 2. In the process, a method for directly feeding the staple fibers from the constant rate feeding means 12 into the mold cavity by solely using the constant rate feeding means 12 can be used or a method for using the constant rate feeding means 12 and a method for using pneumatic transportation can be used in combination.

However, in this case, a space for placing a sliver material is required in a mode in which the sliver is previously prepared. In such an embodiment, it is preferable to feed the sliver by attaching a card in direct connection to the apparatus. Furthermore, it is necessary to prevent disorders in transportation of the staple fibers because of attraction of the staple fibers to the transporting ducts 9A and 9B with static electricity generated during the pneumatic transportation. Because of this, a humidity regulating means or a destaticizing apparatus for preventing the static electricity from generating around the air blowing apparatus for the staple fibers is preferably used.

As mentioned above, when the individual filling of the cavities of the right design surface mold member 1 and the back design surface mold member 2 kept in the developed state with the staple fibers FA and FB is completed, respectively, divided staple fibers FA and FB which separately fill the mold cavities are mutually superimposed and united to form one large lump of the staple fibers (united staple fibers). The large lump of the staple fibers thus united into one is hot-molded to afford a molded product. The steps will be explained in detail hereinafter.

In order to initially mutually unite the staple fibers FA and FB which separately fill the mold cavities in filling surfaces into one large lump of the staple fibers, a foldable mold structure capable of placing the right design surface mold member 1 and the back design surface mold member 2 in the developed state during filling of the staple fibers and mutually uniting the staple fibers in the filling surfaces after completing the filling of each mold cavity with the staple fibers as exemplified in FIG. 1 described above is adopted in the present invention. In the process, an outer frame 3 fulfilling the role of a mold clamping guide member is integrally formed in the back design surface mold member 2 as shown in the figure. The mold members are clamped by sliding the outer peripheral surface of the back design surface mold member 2 on the inner peripheral surface of the outer frame 3 and the staple fibers are compressed to a prescribed density during the clamping of the mold members. In addition, the right design surface mold member 1, the back design surface mold member 2 and the outer frame 3 in the developed state have a structure for combining the staple fibers FA and FB in mutual filling surfaces and joining the staple fibers FA and FB as shown in FIG. 2 by folding up the right design surface mold member 1, back design surface mold member 2 and outer frame 3. The staple fibers FA and FB can be combined and molded into an integrated molded product in the subsequent hot-molding step as mentioned above.

In FIG. 1, a structure freely foldable through a hinge 7 as a folding back means for the mold is realized for folding up the right design surface mold member 1, the back design surface mold member 2 and the outer frame 3 in the developed state. In this case, the right design surface mold member 1, the back design surface member 2 and the outer frame 3 in the developed state can be folded up and united while accurately positioning the right design surface mold member 1, the back design surface mold member 2 and outer frame 3 in the developed state through the hinge 7 which is the folding back means. When folding up the mold, it is preferable to operate the suction apparatus 6A and 6B and present a state in which the staple fibers FA and FB are attracted to the right design surface mold member 1 and the back design surface mold member 2 with the suction apparatus 6A and 6B, respectively. This is because the staple fibers can be held with air streams when the mold member 1 and/or mold member 2 are moved (only the mold member 2 is moved in the example of FIG. 1) and the staple fibers can be superimposed without losing the shape of the staple fibers deposited or laminated and filling the mold members as described above.

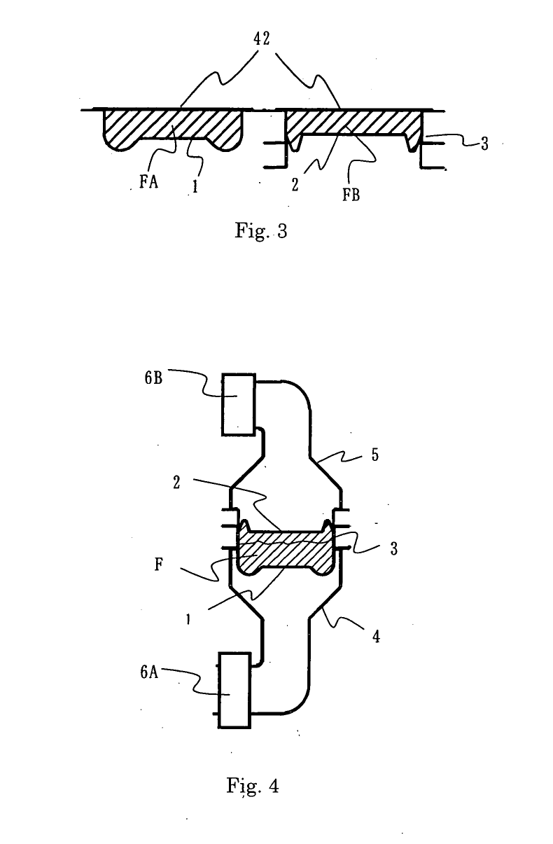

Furthermore, it is a preferable mode of closing an opened surface for filling the right design surface mold member 1 and the back design surface mold member 2 with the staple fibers while leaving gas permeability with auxiliary mold members 42 having the gas permeability as shown in FIG. 3, if necessary, i.e. preventing the filled staple fibers FB from dropping or moving to another place by providing the lids such as the auxiliary mold members 42 when the back design surface mold member 2 is turned upside down. However, in the case, it is necessary to remove the auxiliary mold members 42 after completely uniting the staple fibers or just before uniting the staple fibers. A product after completing hot-molding using the same material as that the staple fibers used for molding of the present invention, if necessary, can be used or a material having hot adhesion and separate from the staple fibers may be used. Since the auxiliary mold members 42 per se as the same material as that of a molded product are assembled in a part of the molded product by the procedures, labor of individually removing the auxiliary mold members 42 can be avoided as opposed to the case mentioned above.

A united mold cavity composed of the right design surface mold member 1, the outer frame 3 and the back design surface mold member 2 is composed in a state of applying suction with the suction apparatus 6A and 6B as shown in FIG. 4 by using the auxiliary mold members 42 or the like, if necessary as described above. Thereby, the staple fibers which fill each mold cavity are hermetically sealed and united. When the divided staple fibers are united as mentioned above, it is a preferable mode of providing an auxiliary heating means in which illustration in figure is omitted before uniting and partially heating the united parts of the divided staple fibers to be united in an auxiliary manner to improve joining properties of the mutual divided staple fibers in the united parts. It is also a preferable mode of sprinkling or coating the united surfaces with an adhesive material or an adhesive, if necessary. In addition, the interior of the fiber aggregate is sprinkled or coated with an ultraviolet light absorber, hygroscopic agent, a flavor agent or the like without any limitation to the adhesive material or adhesive. In the process, it is possible to make the auxiliary mold members play a role thereof to prevent the staple fibers from moving when the back design surface mold member 2 is turned upside down especially by carrying out the auxiliary heating for the back design surface mold member 2 to be turned upside down and fusing only the staple fibers in the surface part of the filled FB.

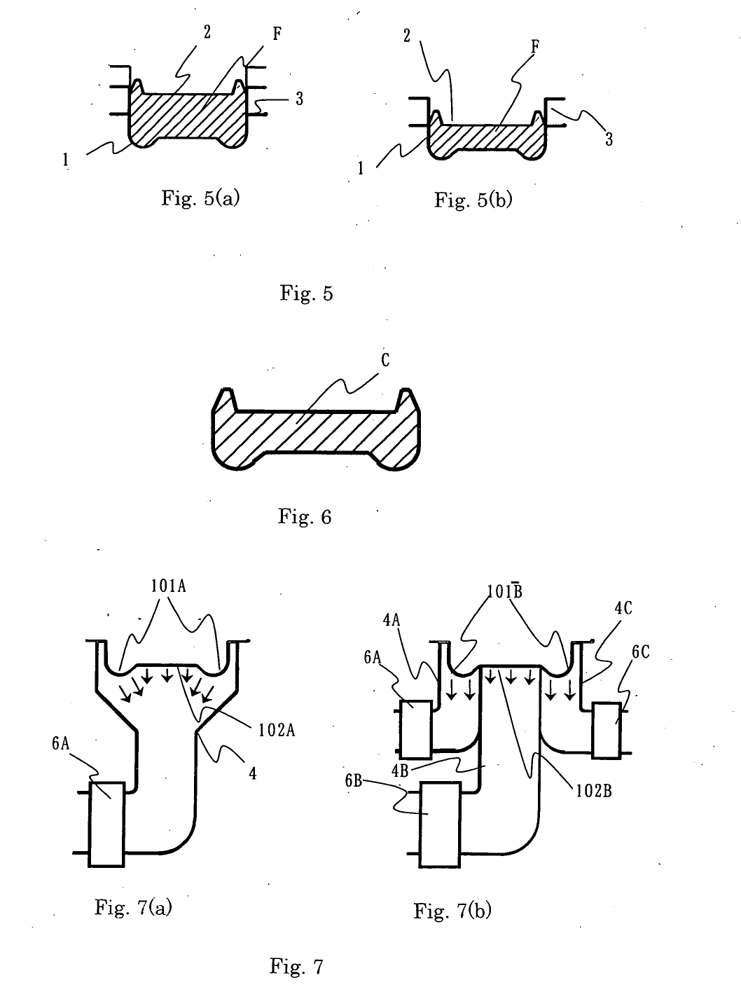

Thus, when the united staple fibers F are formed, a prescribed density is obtained by stopping operation of the suction apparatus 6A and 6B, stopping suction of air and compressing the staple fibers which fill the mold cavities. An explanation for regulation of density of the staple fibers 30′ by compression will be made in detail while referring to FIG. 5. FIG. 5(a) illustrates a state in which the divided staple fibers FA and FB are mutually superimposed and united in the blowing surfaces in an intact state of the divided staple fibers FA and FB blown in the mold cavities. FIG. 5(b) illustrates a state in which the united staple fibers F obtained by uniting the divided staple fibers FA and FB are compressed with the back design surface mold member 2. As shown in FIG. 5 (refer also to FIGS. 1 to 4), the back design surface mold member 2 and the outer frame 3 which is also the mold clamping guide member are integrally formed and the outer peripheral surface of the back design surface mold member 2 is composed so as to freely slide in the compressing direction of the staple fibers relatively to the inner peripheral surface of the outer frame 3 which is the mold clamping guide member. Therefore, the united staple fibers F [the state of FIG. 5(a)] which fill the integrated mold cavities can be compressed to a prescribed filling density [the state of FIG. 5(b)] by the freely movable back design surface mold member 2 to readily carry out the regulation of the density of the united staple fibers F. Thus, the united staple fibers F are compressed with the back design surface mold member 2 to freely regulate the filling density of the united staple fibers F and hot-mold the staple fibers F. Thereby, characteristics such as the degree of stiffness, repulsion and gas permeability when formed into a molded product, for example a cushion material are freely regulated.

As for the compression of the united staple fibers F, clamping of the mold members filled with the staple fibers further at least once in any step before heating, during heating, after heating and during cooling of the united staple fibers after uniting the staple fibers before heating, during heating or just after heating is effective in stabilizing the shape of the molded product by heat shrinkage of the staple fibers caused in molding. Furthermore, a dimensional change due to shrinkage or the like of the molded product in hot-molding is absorbed to improve the dimensional stability of the molded product by carrying out multistage compression.

From the aspects, the positioning control of the back design surface mold member 2 during clamping of the mold members is extremely important. It is necessary to accurately position the back design surface mold member 2 by a top position where the united staple fibers F are filled and united as shown in FIG. 5(a) and a lowered position where the compression of the united staple fibers F is completed by clamping of the mold members as shown in FIG. 5(b). Therefore, the outer frame 3 serving also as the mold clamping guide member is provided with a positioning and stopping means for stopping the back design surface mold member 2 when the back surface design mold member 2 is lowered to a prescribed position though a detailed explanation thereof is omitted herein. It is important that a mechanism (not shown) for positioning in order to maintain the lowered position of the back surface design mold member 2 by the means is installed. In the process, the positioning may be regulated so as to be performable in many stages of three or more stages. In addition, to make sure, one example thereof includes a positioning mechanism for installing stoppers at the lifted end and lowered end of the back design surface mold member 2, surely stopping the movement of the back design surface mold member 2 and pressing the back design surface mold member 2 against the stoppers with urged force of a spring or the like. A commercially available hydraulic operating cylinder having a positioning mechanism operable under a hydraulic or air pressure or the like can be used as other publicly known methods and means.

In the process, it is a preferable mode that the right design surface mold member 1, the back design surface mold member 2 and the outer frame 3 are freely detachable from the chambers 4 and 5 shown in FIG. 1, respectively. This is because the apparatus exemplified in FIG. 1 can be used as an apparatus for exclusive use employed only in a staple fiber filling step such as blowing of the staple fibers according to the mode. Thereby, the mold members 1 and 2 and the outer frame 3 having the staple fibers F united by completing the filling of the staple fibers in the interior and kept in a mold clamped state or a developed state can initially be removed from the filling apparatus for the staple fibers and moved to a separately installed heat-treating apparatus (not shown). Hot-molding of the molded product can be carried out together with the mold members 1 and 2 and the outer frame 3 in a place separate from the filling apparatus for the staple fibers using the heat-treating apparatus.

Advantages thereof are as follows. A plurality of mold members wherein the cavities are filled with the staple fibers can be prepared and the mold members group can be heat-treated in the heat-treating apparatus at a time in molding requiring a long heat-treating time. Thus, the heat-treating efficiency of the molded product can be raised and mass production and cost reduction can be carried out. In the heat treatment, it is needless to say that the staple fibers F can be pressed with the back design surface mold member 2 by any of steps before heating, during heating, after heating and during cooling and/or a combination thereof in the heat treatment to absorb heat shrinkage of the molded product C and improve the shape stability of the molded product. Thereby, the dimensional stability can be improved and shaping of the mold form into the molded product can accurately be carried out.

By the way, when the mold members are charged into the heat-treating apparatus, the staple fibers FA and FB kept in the developed state are charged (auxiliary mold members 42 having gas permeability may be set in the openings of the right design surface mold member and the back design surface mold member as illustrated in FIG. 3 so as to press the mold packed staple fibers FA and FB and prevent movement) and the right design surface mold member 1 and the back design surface mold member 2 may be united during heating and/or after heating without uniting the right design surface mold member and the back design surface mold member as shown in FIG. 3. The same molding step as described above is carried out after uniting the mold members 1 and 2. However, there are disadvantages in that the equipment constitution is complicated by carrying out the molding. In spite of the disadvantages, there are extremely great advantages in that the heating time can remarkably be shortened when a cushion having an especially great thickness or a material having low gas permeability is used.

Thus, as finally exemplified in FIG. 6, the staple fibers F are heat-treated. In the process, the binder fibers dispersed and mixed in the matrix fibers constituting the staple fibers are melted or softened and heat bonded at their crossing points with the binder fibers. Furthermore, the binder fibers are solidified by subsequent cooling to mold the molded product C composed of the fiber structure wherein the mutual fibers are fused. As exemplified in FIG. 6 defective molded parts CA′ caused by a conventional method as exemplified in FIG. 17 are not produced in the molded product C of the present invention thus molded. Therefore, the method of the present invention has excellent effects on obtaining of the molded product having a complicated shape.

Other various embodiments will be explained about the method and apparatus of the present invention mentioned above hereinafter.

In the present invention, first of all, it is a preferable embodiment in which filling of the mold with the staple fibers is controlled on the basis of the time for staying in each site of the filling nozzle in order to control the filling density of the staple fibers in each cavity site of the mold. In addition to the embodiment, as shown in FIG. 7, there is an embodiment for carrying out the density control so as to partially vary the filling density of the staple fibers in the cavity, respectively. When an explanation is first made from the embodiment of FIG. 7(a), an example for locally varying the gas permeability of each site of the mold and forming parts 101A having raised gas permeability of the mold and a part 102A having lowered gas permeability is shown in the embodiment. In this case, it is the embodiment for locally increasing the filling of the staple fibers in the parts 101A by stronger sucking of air in the parts 101A having the raised gas permeability than the other part 102A. In order to locally vary the gas permeability of each cavity site in the mold, operation can be performed by varying the pore diameter of pores drilled in the mold or varying the number of pores in order to provide, for example the gas permeability. When a wire net or the like are used, the operation can be performed by varying the weaving texture thereof.

FIG. 7(b) is an embodiment in which the chamber 4 illustrated in FIG. 7(a) is trisected into chambers 4A, 4B and 4C and auxiliary suction apparatus 6A, 6B and 6C are partially installed corresponding to each of the parts 101B intended to raise the filling density and the other part 102B separately from the gas permeability of the mold. According to the embodiment, the parts 101B intended to raise the filling density can be more strongly sucked from the back surface of the mold than the other part 102B and the filling density of the staple fibers in the parts 101B can thereby be raised. It is needless to say that a method for varying the gas permeability can be used in combination in the embodiment of course.

Feedback control so as to detect a change in suction pressure in each site of the mold and correct the residence time of the filling nozzle on the basis of the change in the suction pressure is also a preferable mode. Furthermore, one auxiliary suction apparatus can be provided besides the embodiment in which the plurality of auxiliary suction apparatus 6A, 6B and 6C are partially installed on the back surface of the mold. For example, the chamber is divided into each of the chambers 4A, 4B and 4C and a flow rate regulating means such as a known damper can be installed for each of the chambers 4A, 4B and 4C to freely regulate the flow rate of air sucked by the auxiliary suction apparatus with each of the chambers 4A, 4B and 4C.

As mentioned above, suction force according to the staple fiber packing density in each site of the mold cavity can be obtained by optimally regulating the gas permeability and air suction force in each site of the mold cavity. Thereby, the amount or filling density of the staple fibers which fill the mold can partially be regulated.

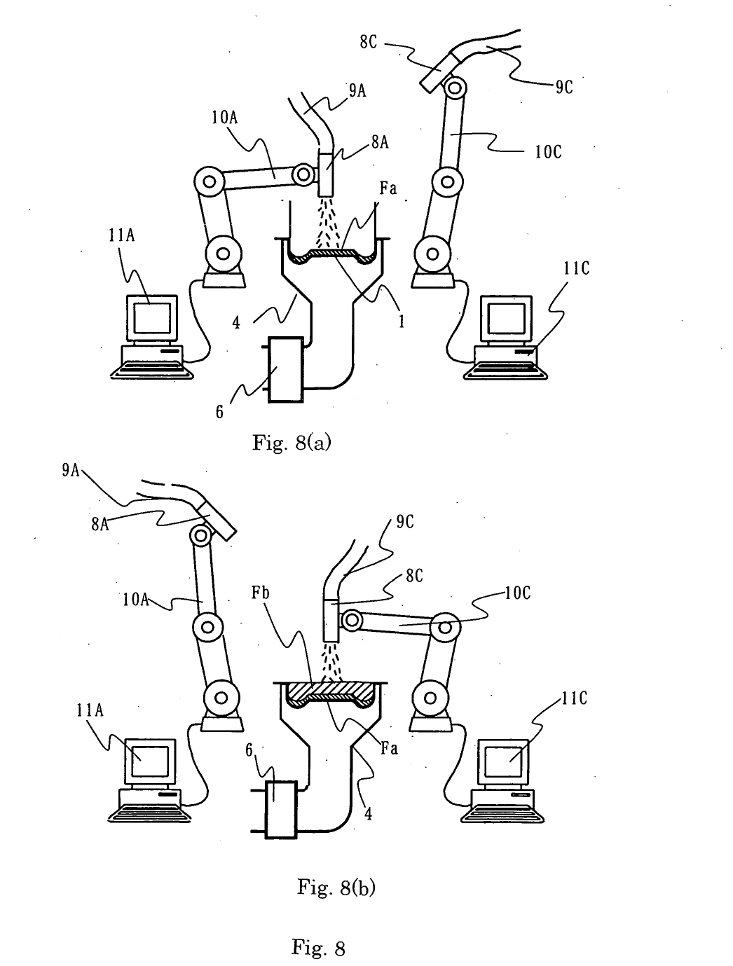

When an explanation about the embodiments of FIG. 8 is made, the figures are embodiments exemplifying methods and apparatus for laminating auxiliary materials such as different kinds of staple fibers, staple fibers in a different blending ratio or heat bonding materials in a multilayered form. The embodiments comprise a step of initially packing staple fibers Fa of a first layer which fill the mold cavity as illustrated in FIG. 8(a) and a step of packing staple fibers Fb of a second layer subsequently to the step as illustrated in FIG. 8(b). The filling steps of the staple fibers Fa and Fb are preferably carried out while performing suction from the back surface of the mold member 1 with the suction apparatus 6. FIG. 8 exemplifies only an embodiment for blowing filling in the right design surface mold member 1; however, the step of filling the back design surface mold member 2 with the staple fibers is omitted herein for simplifying the explanation because the filling step can be carried out by the same method and apparatus.

When an air blowing method is adopted, the same method and apparatus as illustrated in FIG. 1 are used to fill the right design surface mold member 1 with the staple fibers Fa fed from the duct 9A through the filling nozzle 8A held by a robot arm 10A controlled with a controller 11A in the step of packing the staple fibers Fa of the first layer exemplified in FIG. 8(a). In the process, it is needless to say that the deposition height of the staple fibers Fa deposited on the right design surface mold member 1 is determined by the moving speed of the filling nozzle 8A held by the robot arm 10A controlled with the controller 11A and the carrier air flow rate, the amount of the staple fibers blown off from the nozzle 8A or the like. Thus, when the filling of the right design surface mold member 1 with the staple fibers Fa of the first layer is completed, filling of the staple fibers Fb of the second layer is carried out as exemplified in FIG. 8(b). In the step of packing the staple fibers Fb of the second layer, the right design surface mold member 1 is filled with the staple fibers Fb fed from the duct 9C through the filling nozzle 8C held by the robot arm 10C controlled with the controller 11C.

In the case of the step of filling the staple fibers of the second layer, as exemplified in FIG. 8(b), the other robot arm 10C can be used, but the robot arm 10A used in the step of filling the staple fibers of the first layer can subsequently be used. In this case, the robot arm 10A shifts the filling nozzle 8A to the filling nozzle 8C to pneumatically transfer the staple fibers Fb fed from the duct 9C through the filling nozzle 8C shifted from the filling nozzle 8A to fill the mold cavity with the staple fibers Fb.

Thus, when the filling of the staple fibers in the mold cavities is completed, the right design surface mold member 1 is united with the back design surface mold member 2 to carry out clamping of the mold members and the united mold members are fed to the heat-treating step as mentioned above. There may be a case wherein the mold members 1 and 2 are not united, kept in an opened state and fed to the heat-treating step as already described above.

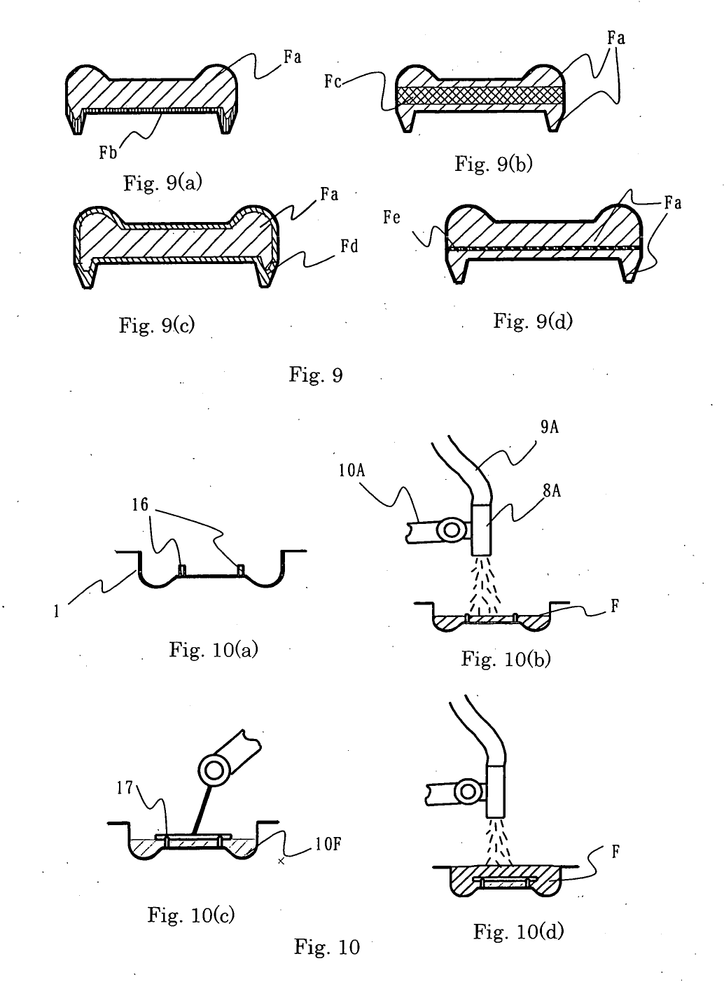

The above explanation is an embodiment of a case wherein the staple fibers Fa and Fb of two layers (layers of different kinds and layers of different blending ratios) and then hot-molded to afford a molded product. The multilayered lamination of three or more layers can be carried out in the same manner. Therefore, the embodiments will be explained in detail hereinafter by referring to FIG. 9.

FIG. 9 is a sectional view of a molded product obtained by heat-treating staple fibers filled according to multilayered lamination of three or more layers with the method and apparatus described above. FIG. 9(a) is an illustration of a hard spring receiving material layer Fb laminated onto the side of the back design surface; FIG. 9(b) is an illustration of an improvement in cushion properties or cost of the molded product by laminating a material Fc of a different kind onto the interlayer of the molded product; FIG. 9(c) is an illustration of a material Fd such as a flameproof material or a skin material laminated to the surface layer; and FIG. 9(d) is an illustration of a molded product obtained by laminating a heat bonding material Fe between layers which are difficult to thermally fuse, respectively. In the present invention, it is needless to say that the embodiment need not be limited to the multilayered lamination form exemplified in each embodiment of FIG. 9 and, for example a form other than the lamination form in which lumps of staple fibers as the middle staple fibers are partially deposited and arranged in the interior of the mold can readily be adopted.

In the process, when a cushion material is molded into the molded product, for example thick single staple fibers having a single fiber fineness of 10 to 200 dtex may be used in the interlayer part to form a highly repulsive layer. In order to improve cushion properties, a fiber layer of fine single fiber fineness of about 2 to 10 dtex may be formed. In addition, the molded product may be produced by finely cutting or forming the molded product formed from the staple fiber material used in the present invention into the state of small lumps or mixing an adequate amount of the raised material with the staple fibers which are raw materials. Advantages of carrying out the operation include the fact that the cost of the molded product can be more reduced or the molded product can easily be recycled f or use or the like. The binder fibers or spunbonded materials composed of polyethylene terephthalate (PET) or the like described above can preferably be used as a material of thermally fusible fibers used as a means for bonding spaces between layers which are difficult to thermally fuse or a means for providing a hard layer to a certain layer.

FIG. 10(a) to FIG. 10(d) are drawings exemplifying a production step of assembling various kinds of components attached to the molded product for fixing the molded product in the interior of a molded product or fixing a cover covering the surface of the molded product in the molded product during filling of the staple fibers. Examples of the various kinds of components described above include a netlike material, a nonwoven fabric lump, a nonwoven fabric sheet and/or other woven or knitted fabrics or the like composed of a wire, a metal rod, a plastic material, a metal wire net, a synthetic fiber woven fabric or knitted fabric and a supporting member or the like for installation thereof.

In FIG. 10, FIG. 10(a) illustrates a sectional view of a mold provided with the supporting members 16 for setting the various kinds of components in specific positions; FIG. 10(b) illustrates a former half step of packing the staple fibers; FIG. 10(c) is a step of setting the components 17; and FIG. 10(d) illustrates a latter half step of packing the staple fibers, respectively. Although the setting of the components 17 may be carried out by a human, it is preferable to carry out the setting with an automatic machine such as a robot arm 10F from aspects of automation of the process. It is needless to say that the robot arms 10A to 10E already mentioned in separate embodiments, if necessary, can be diverted to the robot arm 10F for use. In the process, it is needless to say that the step of setting the components 17 is carried out in any timing of before packing, during packing or after packing of the staple fibers F into the mold corresponding to the shape or assembling position thereof. The components 17, if necessary, may be set on either one of the top surface of the supporting members 16 installed in the mold member 1 or the top surface of the laminated staple fibers F. In the present invention, when the divided members of the mold in which the divided staple fibers are filled are heat-treated in the developed state, respectively, the divided members of the mold are kept in the developed state, that is, an opened state. Therefore, the setting of the various kinds of components during hot-molding and/or after heating is also a preferable mode.

The various kinds of components 16 or 17 can well be assembled in the interior of the molded product by a filling step of the staple fibers F or, if necessary, a heating step by using the method and apparatus of the present invention as mentioned above. That is, in the present invention, the aimed site of the mold cavity can be filled with an aimed amount of the staple fibers F by using the filling nozzle 8A. Therefore, the staple fibers can be filled without causing problems of catching the staple fibers with obstacles even when the supporting members 16 or the various kinds of components 17 are installed in the mold cavity as described above. When the divided members of the mold are heat-treated in the developed state, the various kinds of components can be set during the hot-molding and/or after heating.

Furthermore, the supporting members 16 or various kinds of components 17 can be installed in the interior of the mold cavities with the robot arms 10A to 10E as already mentioned above. The members can be installed in any timing of before packing, during packing or after packing of the staple fibers F in the mold. As a result, the supporting members 16 and 17 can be installed by suitably and temporarily removing obstacles or temporarily stopping filling of the staple fibers F according to the progress of the filling of the staple fibers F so as not to cause trouble with the supporting members 16 or various kinds of components 17.

An explanation about the embodiment described above will specifically be made in detail hereinafter. As shown in FIG. 10(a), the supporting members 16 without causing trouble in filling of the staple fibers are initially placed in the mold member 1 with the robot arm 10A or the like. As illustrated in FIG. 10(b), the peripheries of the supporting members 16 are then filled with the staple fibers F. In the process, a pushing means described below (not shown in FIG. 10) may be used to compress and fill the staple fibers F. As shown in FIG. 10(c), the components 17 such as a netlike material, a nonwoven fabric lump, a nonwoven fabric sheet and/or other woven or knitted fabric or the like composed of a wire, a metal rod, a plastic material, a metal wire net or a synthetic fiber woven fabric or knitted fabric are placed on the supporting members 16. In addition, it is needless to say that the components 17 pose an obstacle and staple fiber packing cannot sufficiently be carried out when the components 17 are installed in the mold member 1 in the stage illustrated in FIG. 10(a) before blowing the staple fibers F in the step. The interior of the mold member 1 can finally be filled with a required amount of the staple fibers F as shown in FIG. 10(d) to thereby fill the interior of the mold member 1 with the staple fibers F without unevenness of filling.

In contrast to this, when the various kinds of members 16 and 17 are assembled in the mold cavity before filling the staple fibers F, it is needless to say that problems of catching the blown staple fibers F by the members 16 and 17 or creating sites where the staple fibers are difficult to fill at the back of the members 16 and 17 or the like provided in the mold cavity are caused by a conventional filling method, especially a conventional air blowing filling method. Therefore, in order to eliminate the problems, the mold cavity is filled with the staple fibers by blowing and heat-treated to provide a molded product and drilling or the like for assembling the various kinds of components 16 and 17 are then carried out in a conventional method. Thus, the excessive step becomes essential to the conventional method; however, the step can be omitted or remarkably simplified in the present invention.

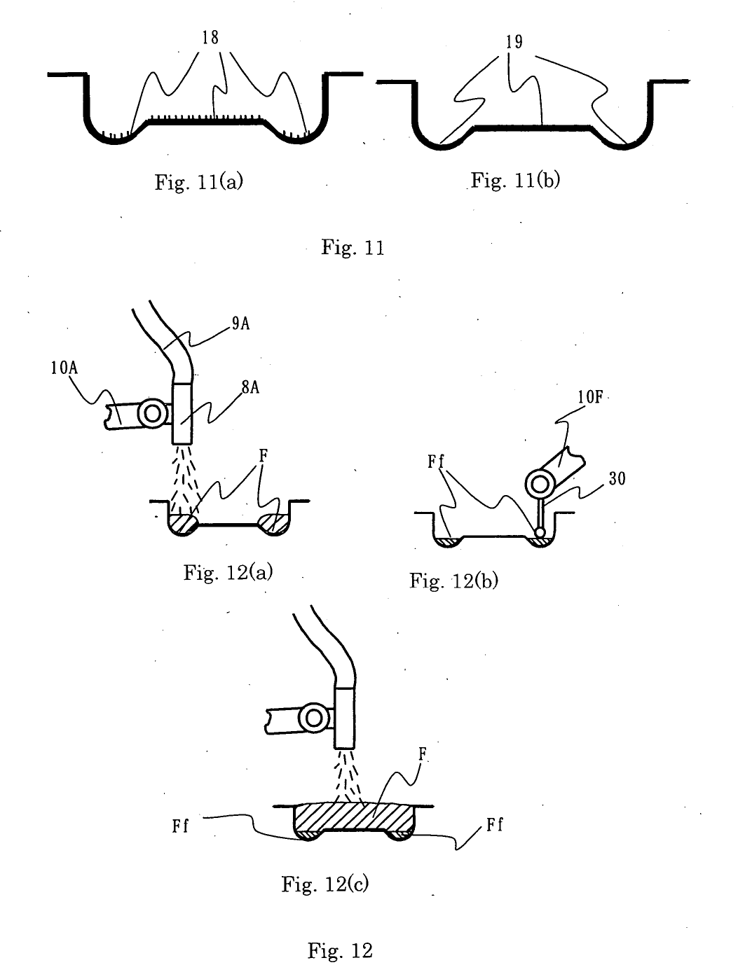

An explanation about the embodiment exemplified in FIG. 11 will then be made hereinafter. The embodiment indicates a means for improving the properties of the staple fibers which fill a deep drawn part of the mold and preventing the filled staple fibers from shifting on the mold wall surface. That is, FIG. 11(a) illustrates an example of embodiments in which needles 18 are installed in parts having a shape close to a horizontal surface of the mold wall and FIG. 11(b) illustrates an example of embodiments in which the surface roughness of the mold surface in parts having a shape close to the horizontal surface of the mold cavity is set rough, respectively. However, the surface of the mold wall is formed smooth in other parts close to vertical surfaces. Thus, the coefficient of surface friction of the mold wall surface in parts close to the vertical surface can be reduced and the staple fibers can be made to easily slip in the filled surface in parts close to the vertical surfaces and readily inserted into the deep drawn part. The staple fibers are made to hardly slip on the filling surface of the mold and once set staple fibers do not transversely shift with suction force by a suction apparatus 4 or the like or wind force or the like with carrier air from the filling nozzle of the staple fibers by setting the coefficient of surface friction of the mold wall surface in parts close to the horizontal surface at a high value or installing needles.

FIG. 12 exemplifies a staple fiber packing step by which staple fibers can well be packed even in extremely deep drawn parts which cannot be solved even by the method and apparatus according to FIG. 11 described above. In FIG. 12(a), the deep drawn parts are filled with the staple fibers F at a high density by increasing the filling density according to pressing and compressing of the staple fibers F with a rod 30 which is a pushing means fixed to the robot arm 10F or the like during blowing of the staple fibers or setting the additional staple fibers at the tip of the rod 30 as an auxiliary filling means and pressing the staple fibers while feeding the staple fibers to the deep drawn parts. In addition, a pressurized air blowing means (not shown) for blowing pressurized air in an auxiliary manner during pushing of the staple fibers, as necessary, may additionally be installed in the rod 30 of FIG. 12(a). As for the additional filling described above, it is needless to say that an optional material other than the staple fibers, if necessary, can be filled without necessity of limitation only to the staple fibers F.

In the process, as illustrated in FIG. 12(c), the parts other than the deep drawn parts can be filled with the staple fibers according to a usual manner with the method and apparatus of the present invention mentioned in FIG. 1. Filling of the deep drawn parts where there are limits only by an air blowing method with the staple fibers (parts Ff in the figure) at a high density can be realized by adopting the filling method even when the air blowing method is adopted for filling the staple fibers F. Thus, the auxiliary filling means as described above, if necessary, can be used to fill or laminate extremely deep drawn parts where filling is extremely difficult by a conventional method and a solution cannot easily be reached even by strengthening suction force and finishing of the mold surface according to the present invention described above with the staple fibers at a high density.

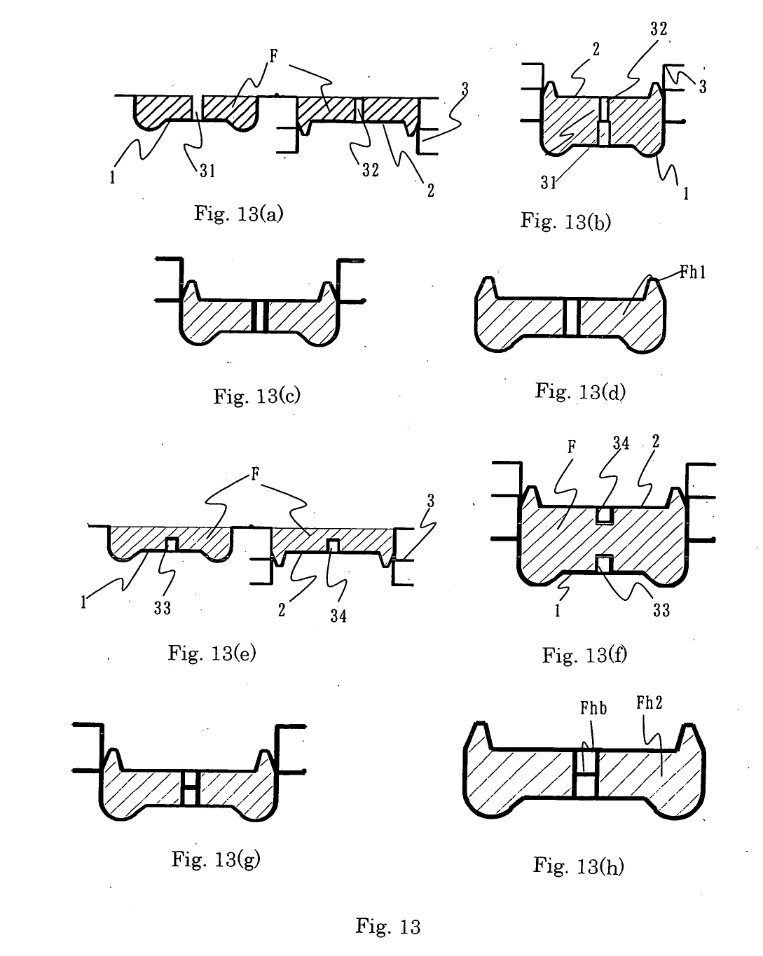

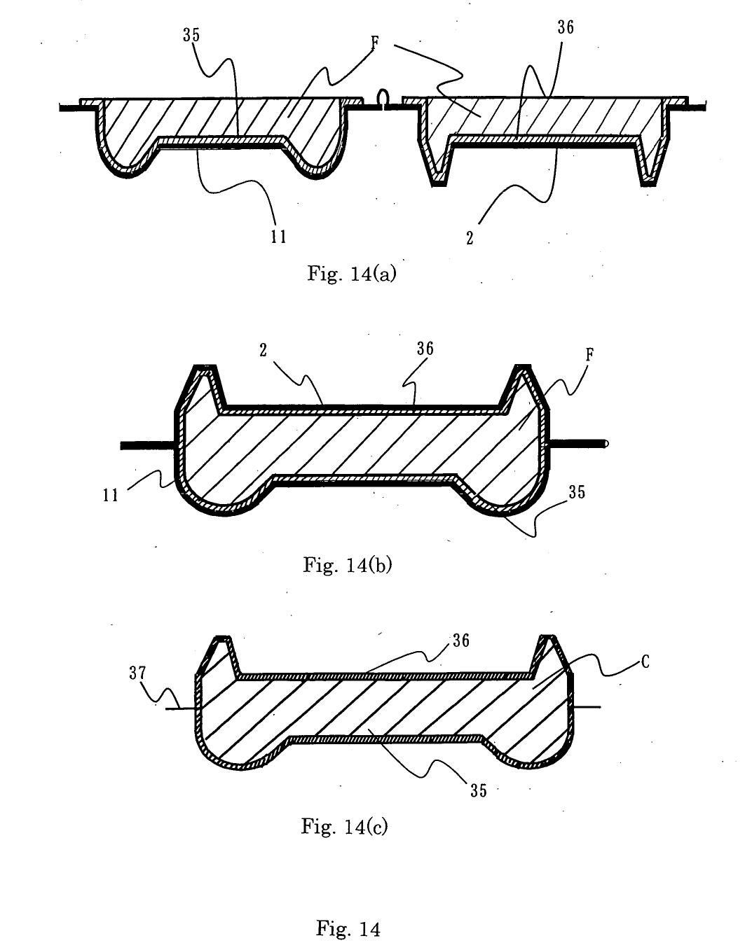

Furthermore, a molded product having a drilled part formed therein can be molded and a drilling step after molding is not required or is extremely facilitated by adopting an embodiment using a mold exemplified in FIG. 13 when formation of an opening in the molded product such as drilling is requested. Thus, an explanation about the embodiment in the case will be made in detail hereinafter by referring to FIG. 13.

FIG. 13(a) exemplifies a state in which the mold members 1 and 2 are already filled with the staple fibers F for forming the drilled part in the molded product. It is needless to say that the filling of the mold members 1 and 2 with the staple fibers F can readily be carried out by the method and apparatus of the present invention as already mentioned above. Therefore, an explanation about the filling step is omitted.

An explanation about the mold members 1 and 2 of FIG. 13(a) will be made hereinafter in more detail. A female jig 31 for drilling is additionally installed in the one right design surface mold member 1 and a male jig 32 fitting into the inner peripheral surface of the female jig 31 for drilling is additionally installed in the other back design surface mold member 2. In the process, the male jig 32 and the female jig 31 are positioned and installed so as to insert the male jig 32 into the female jig 31 when the mold member 1 is folded up on the mold member 2. Therefore, the male jig 32 is inserted into the female jig 31 while being fitted thereinto by sliding the mold member 2 downward along the inner peripheral surface of the outer frame 3 serving also as a metal clamping guide member in a state wherein the mold members 1 and 2 kept in the developed state are folded up and united. (i.e. the state of the clamping of the mold members 1 and 2 which are positioned and integrally assembled) as in the state of FIG. 13(a) to the state exemplified in FIG. 13(b). As exemplified in FIG. 13(c), a state in which the staple fibers F are absent in the interior of the male jig 32 is then realized by moving the mold member 2 to the lowering end. When the staple fibers F are heat-treated in the state, it is needless to say that an opening is formed in the resulting molded product in the same manner as the practice of drilling. The molded product having an opening (hole) as illustrated in FIG. 13(d) can be hot-molded and simultaneously formed by carrying out hot-molding in the state illustrated in FIG. 13(c).

In contrast to the embodiment, FIG. 13(e) to FIG. 13(h) illustrate another embodiment for drilling the molded product. In the figures, reference symbols 33 and 34 are drilling jigs separate from those illustrated in FIG. 13(a) to FIG. 13(c). In the process, a heating means (not shown) such as a heater may be provided in the female jig 33 and male jig 34 in order to obtain auxiliary heating effects. Drilling using the jigs 33 and 34 is herein carried out as follows.

As exemplified in FIG. 13(e), the mold members 1 and 2 are initially filled with the staple fibers F. The mold members 1 and 2 are then folded up as exemplified in FIG. 13(f). That is, the divided mold members 1 and 2 are placed in a state of clamping of the mold members in which the mold members 1 and 2 are positioned and integrally assembled. In the process, it is a preferable mode for melting the staple fibers present in a site for admitting the female jig 33 or the male jig 34 by a heating means additionally installed in the female jig 33 and the male jig 34 so as to well perform the drilling. In this case, heating may be carried out by adding a role of the heating means to the female jig 33 and the male jig 34 and directly energizing the female jig 33 and male jig 34 which are also the heating means. In the folded up state, the mold member 2 is slid and lowered on the inner peripheral surface of the outer frame 3 serving also as the mold clamping guide member. In the process, as illustrated in FIG. 13(g), the tips of the jigs 33 and 34 are mutually positioned so that the tips can mutually and accurately be brought into contact at the lowered end or brought into contact at a slight gap kept therebetween. That is, the two jigs 33 and 34 are positioned so as to mutually align each center line of the jigs 33 and 34 in a butted state of the two jigs 33 and 34 provided so as to be opposite.

When the staple fibers F are heat-treated in the states, a molded product as exemplified in FIG. 13(h) can be obtained. However, in the molded product, thin high-density flashes Fhb are produced in a mating surface of the jigs 33 and 34 as illustrated in FIG. 13(h). The thin high-density flashes Fhb can simply be removed from the molded product in a trimming step carried out after the hot-molding. Even when the flashes intactly left in the molded product, the flashes can readily be removed in a stage of inserting the parts into the opening. Furthermore, the flashes may be melted and removed by the heating means such as heaters additionally installed in the female jig 33 and the male jig 34.

As mentioned above, since drilling can simultaneously be carried out in molding according to the present invention, the necessity of carrying out the drilling of the product after the molding using a drilling tool is eliminated. Accordingly, there are advantages in that the production process can be shortened and production cost of the molded product can further be reduced.

Skin integral molding which is conventionally extremely difficult to mold a complicated shape of both the right design surface and the back design surface can be carried out according to the method and apparatus of the present invention. The embodiment will be explained in more detail hereinafter by referring to FIG. 14.

In the embodiment, skins 35 and 36 are initially set on the inner peripheral surfaces of the mold members 1 and 2 by a human, with an automatic machine or the like as illustrated in FIG. 14(a), respectively. The mold members 1 and 2 wherein the skins 35 and 36 are set are then filled with the staple fibers F by the method and apparatus of the present invention as already mentioned, respectively. The mold members 1 and 2 are then folded up as exemplified in FIG. 14(b). The skins 35 and 36 and the staple fibers F in the folded up state can thus be heat-treated to integrally mold the skins 35 and 36 and the staple fibers F as exemplified in FIG. 14(c). Since the thin and high-density flash parts 37 produced therein are hard and thin, the flashes can easily be bent and removed. It is needless to say that the flashes can simply be bent and thus manually simply be removed in the same manner as in the thin high-density flashes Fhb in FIG. 13(h) as already mentioned above.

Accordingly, integral molding of the skins 35 and 36 and the staple fibers F which is difficult by a conventional method can simply be carried out to provide a beautiful finish shape by using the method and apparatus of the present invention even when the blowing filling method of the staple fibers is adopted. In the case, a molded product wherein the, whole surface of the molded product is covered with the skin can be produced. When heat-fusible staple fibers are adopted as a lining material of the skins 35 and 36, it is preferable because thermal adhesion to the staple fibers F is further improved.

Examples of the skins herein include a wire, a metal rod, a plastic material, a metal wire net, a netlike fiber woven fabric, a nonwoven fabric block and a nonwoven fabric sheet, a sheetlike material such as a W raschel or a knit or woven fabric or the like. Examples of the other materials of the lining material include a mixture of staple fibers composed of low-crimped matrix fibers with the binder fibers as described above, a mixture of pulpy plastic parts, a Cordelan victoria lawn, a PP nonwoven fabric, Tafnel or the like with the binder fibers as mentioned above or the like. The fiber aggregate is hot-molded by reversing the direction to pass through heated air and/or cooling air at least once when the heated air and/or cooling air are passed through the integral mold after clamping of the mold members composed of the right design surface mold member and the back design surface mold member or mold members in the developed state before clamping of the mold members to carry out heating and/or cooling.

As mentioned above, it is preferable because heating unevenness is eliminated and a good molded product is obtained by passing the heated air and/or cooling air from the side of the right design surface and the side of the back design surface of the mold therethrough in the case of the united mold at least once or passing the heated air and/or cooling air flow from the filling side and the side opposite to the filling of the staple fibers therethrough at least once to uniformly heat and/or cool the staple fibers which fill the mold cavities in the case of the mold in the developed state when the staple fibers are packed in the mold and then hot-molded.

It is more preferable because the molded product is uniformly heated to prevent the deformation during heating, with the result that the minimum extent thereof is caused by passing the heated air and/or the cooling air through a gas-permeable mold from the lower to the upper sides (in the direction opposite to the gravity, i.e. the antigravity direction), then changing the vertical direction of the mold, thereby passing the heated air from the side of the right design surface and the side of the back design surface of the mold each at least once, passing the heated air and/or cooling air therethrough and carrying out heating and/or cooling. In the case, it is needless to say that the auxiliary mold members as mentioned above are used in the opening for filling the staple fibers to close the opening in the same manner as the mold in the developed state and the operation is then performed.

The reason for the operation is that the finish shape of the molded product is changed by the influence of the wind pressure with the heated air and/or cooling air when the heated air and/or cooling air to be passed through the mold are kept in the flow direction from the upper to the lower sides (gravity direction). In contrast to this, the wind pressure of the heated air and/or cooling air and the weight of the molded product are offset by passing the heated air and/or cooling air in the antigravity direction. Thereby, the finish shape of the molded product can be kept good.

When the direction of the heated air is kept from the lower to the upper sides (in the direction opposite to the gravity direction) as mentioned above and the deep drawing protrusions such as finlike protrusions are provided as seen in the molded product in heating after mold packing, it is preferable to pass the heated air through the mold in the state of the protruded surfaces down. This is because the finlike protruded parts which are especially difficult to heat can initially be brought into contact with the heated air by carrying out the operation. Thereby, heat-up properties of the finlike protruded parts can be improved to prevent the deformation of the molded product during heating, with the result that the minimum extent thereof is caused.

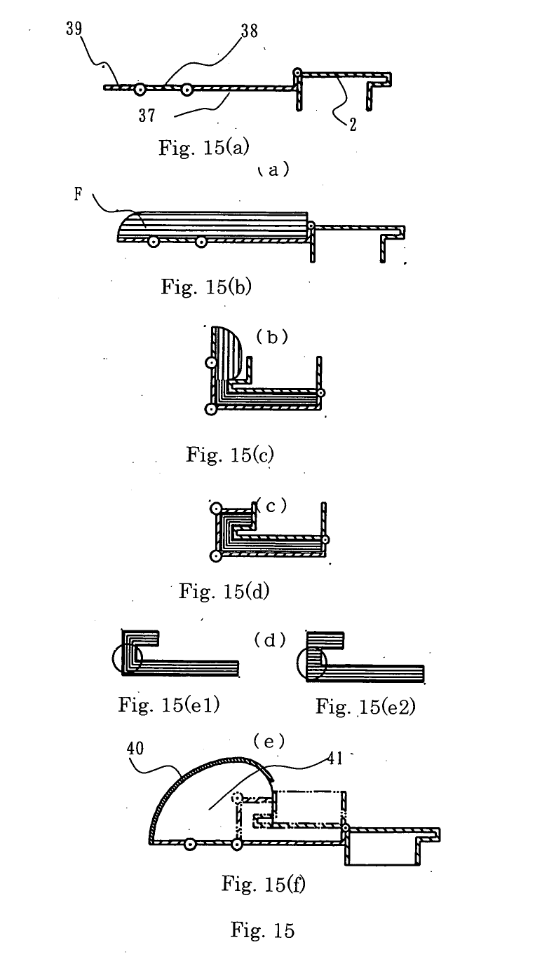

High upright wall parts or pouched wall shapes as found in especially the backrest parts of automotive sheets which are conventionally extremely difficult to mold can be molded according to the method and apparatus of the present invention The embodiment will be explained in detail hereinafter by referring to FIG. 15.

In the embodiment, the staple fibers F are initially set on the inner peripheral surface of the mold member 37 by a human; with an automatic machine or the like as illustrated in FIG. 15(a) to FIG. 15(b). Mold walls 38 and 39 installed on the outer periphery of the mold member 37 are kept in a structure foldable with a hinge or the like. Therefore, the mold walls can-be bent to bend the staple fibers laminated in the upper part thereof. The timing of bending the mold members 38 and 39 to form an upright wall shape or pouched wall shape by bending the mold members 38 and 39 may be during filling of the staple fibers or just after completing the filling of the staple fibers or may be any timing during the heating or after completing the heating by carrying out the heating of the mold kept in the developed state thereof for shortening the heating time and improving the shaping properties. In order to shorten the heating time or simplify the heating conditions, it is preferable to carry out the heating of the mold kept in the developed state thereof. In the process, a lid which is an auxiliary mold member having gas permeability may be set on the staple fibers so as not to move the staple fibers when the heating is carried out in the developed state of the mold. When the developed mold is bent, it is a preferable mode to suck air from the back surface of the cavity and press the staple fibers with the wind pressure of the sucked air and, thereby ensure the shape of the staple fibers so as not to lose the shape thereof.

The mold is further bent, passed through a state of FIG. 15(c) and then changed into a state of FIG. 15(d) to carry out heating and/or cooling. Thereby, the molded product having the upright wall shape or pouched wall shape in FIG. 15(e1) is obtained. When, the method for bending the developed mold, forming the mold cavity and simultaneously filling the staple fibers as in the present invention is adopted, staple fibers can well be filled even when a complicated cavity shape such as the upright wall shape or pouched wall shape which is difficult in filling of the staple fibers by a conventional air blowing method. Since the laminated surface of the staple fibers is formed along the surface of the molded product as exemplified in, FIG. 15(e1), the laminated surface of the staple fibers is not exposed to the outer surface of the molded product as in the case of the conventional molded product exemplified in FIG. 15(e2) and a smooth and beautiful state of the surface finish of the molded product can be exposed. Further, there are problems that the tear strength of the part is markedly lowered and the molded product is simply torn in the laminated surface by the action of force in the tear direction because the laminated surface in the molded product illustrated in FIG. 15(e2) runs toward the outer surface in a site surrounded by a circle. In contrast to this, the problems are not caused in the molded product of the present invention because the laminated surface runs along the outer surface of the molded product.

When the developed divided members 38 and 39 of the mold are moved to the uniting position to provide a united mold in bending the divided members 38 and 39 of the mold as in FIG. 15(f), auxiliary mold walls 40 and 41 are installed on the top surface and side of the divided members 38 and 39 of the mold so as not to move the divided staple fibers which fill the divided members 38 and 39 of the mold from the cavity, respectively. When the divided mold members 38 and 39 of the mold are moved, the staple fibers may be held in the cavity so as not to protrude from the mold cavity. In the process, it is more preferable to serve auxiliary mold walls 40 and 41 as uniting guide means for guiding the divided members 38 and 39 of the mold transferred from the developed state to the united state to the uniting position. The part indicated by the alternate long and two short dashes lines in FIG. 15(f) is a state wherein the divided members 38 and 39 of the mold are moved to the uniting position, united and set in a position for assuming the final mold shape.

In addition, as for the auxiliary mold walls 40 and 41, the auxiliary mold wall 40 forms a sliding surface where the bendable divided members 38 and 39 of the mold slide in the uniting direction while describing a curve and the auxiliary mold wall 41 forms a sliding surface where the side ends of divided members 38 and 39 of the mold slide. The auxiliary mold walls 40 and 41 fulfill also a role as the uniting guide means. In the process, the auxiliary mold walls 40 and 41 may be fixed on the divided members 37, 38 or 39 of the mold or may freely be detachable. As for the auxiliary mold wall 40 forming the sliding surface in the circumferential direction, it is preferable to make the auxiliary mold wall 40 freely detachable, carry out mold packing in a detached state because the auxiliary mold wall 40 becomes an obstacle to packing of the staple fibers in the divided members 37, 38 or 39 of the mold and then set the auxiliary mold wall 40 in the mold members before bending the divided members 38 and 39 of the mold. It is a preferable mode to make the staple fibers readily bendable in the bent part of the divided members 38 and 39 of the mold when the divided members 38 and 39 of the mold are bent by carrying out heating assistance for the staple fibers which fill the mold members together with the formation of cuts or the like easily bent before filling of the staple fibers when the divided members 38 and 39 of the mold are filled with the staple fibers.

### INDUSTRIAL APPLICABILITY

As mentioned above, staple fibers can well be packed along the shape of the mold even if the mold cavity has a shape such as a complicated deep drawing while adopting an air blowing filling method of staple fibers according to the present invention. Furthermore, there can be provided a method for molding with which even integral molding for assembling various components in a molded product or drilling can easily be performed and an apparatus therefor. The method and apparatus are useful for improving cushion performances of the molded product by blowing or laminating the staple fibers of different kinds, staple fibers in different blending ratios and heat bonding materials or the like in many layers and heat treatment for a short time can be carried out even in the case wherein thick molded products or materials having low gas permeability are used. In addition, the method and apparatus are extremely useful because molded products having the complicated shape such as an upright wall shape, a pouched wall shape or a folded wall shape can readily be molded and the bulk density of each site of the molded products can further, easily be controlled to a desired value.

1. A method for molding a fiber aggregate comprising placing divided members of a mold obtained by dividing the mold having gas permeability into the plurality of members in a developed state, filling cavities of the divided members of the mold in the developed state with the fiber aggregate wherein binder fibers having a lower melting point than that of crimped synthetic staple fibers are dispersed and mixed in matrix fibers composed of the crimped synthetic staple fibers, respectively, uniting the divided members of the mold in the developed state, uniting each divided and filled fiber aggregate, heating the united fiber aggregate, melting or softening the binder fibers, fusing the melted or softened binder fibers to the matrix fibers at their crossing points, then cooling and solidifying the melted or softened binder fibers and providing a molded product.

2. The method for molding the fiber aggregate according to claim 1, wherein the divided fiber aggregate before heating, during heating or just after heating is united and the fiber aggregate is further subjected to clamping of mold members in any step before heating, during heating, after heating and during cooling of the united fiber aggregate at least once.

3. The method for molding the fiber aggregate according to claim 1, wherein the auxiliary heating of the united parts of the fiber aggregate is partially carried out when the divided fiber aggregate is united.

4. The method for molding the fiber aggregate according to claim 1, wherein opened surfaces of the divided members of the mold are closed; heating is then started; the fiber aggregate, if necessary, are compressed and the divided members of the mold kept in the developed state are subsequently united during heating and/or after heating.

5. The method for molding the fiber aggregate according to claim 1, wherein the fiber aggregate which fills each divided member of the mold and is kept in the divided state, respectively is united in any step during heating or after heating the fiber aggregate during packing of the fiber aggregate in the divided members of the mold, after packing thereof or the fiber aggregate packed in the mold members after the packing in the mold members and a deep drawing shape, an upright wall shape, a pouched wall shape or a folded wall shape is formed with the united fiber aggregate.

6. The method for molding the fiber aggregate according to claim 1, wherein air in the cavities is sucked from the back surfaces of the divided members of the mold when the divided members of the mold are filled with the fiber aggregate.

7. The method for molding the fiber aggregate according to claim 6, wherein the quantity of air suction from the divided members of the mold during the mold packing is changed at least once.

8. The method for molding the fiber aggregate according to claim 1, wherein the divided members of the mold are divided on the basis of a design surface of the molded product.

9. The method for molding the fiber aggregate according to claim 8, wherein the divided members of the mold are composed of a right design surface mold member and a back design surface mold member which are freely folded up and/or bent and each fiber aggregate which fills each mold member is united and integrated when the mold is folded up and/or bent.

10. The method for molding the fiber aggregate according to claim 9, wherein the right design surface mold member and the back design surface mold member are united while carrying out suction from the back surfaces of the right design surface mold member and the back design surface mold member kept in the developed state.

11. The method for molding the fiber aggregate according to claim 1, wherein the fiber aggregate opened into the form of small lumps is accompanied and carried with an air stream to fill a desired cavity part of each divided member of the mold.

12. The method for molding the fiber aggregate according to claim 11, wherein the gas permeability of the wall surface of each divided member of the mold and/or quantity of air suction from the back surface of each divided member of the mold are changed and the fiber aggregate in an amount according to each cavity site of each divided member of the mold is filled in a laminated and/or a lump state.

13. The method for molding the fiber aggregate according to claim 1, wherein a predetermined cavity site of each divided member of the mold is filled with the fiber aggregate composed of different kinds of materials, a material in a different blending ratio of the matrix fibers and the binder fibers, a thermal adhesive or a thermal adhesive material and/or heat bonding fibers.

14. The method for molding the fiber aggregate according to claim 1, wherein various kinds of components attached to the molded product during heating and/or after heating the fiber aggregate which fills the divided members of the mold in any one or more stages before filling, during filling and after filling or in the developed state before hot-molding are assembled in the divided members of the mold when each divided member of the mold is filled with the fiber aggregate by blowing.

15. The method for molding the fiber aggregate according to claim 14, wherein the various kinds of components are composed of a netlike material, a nonwoven fabric lump, a nonwoven fabric sheet and/or other woven or knitted fabrics thereof composed of a wire, a metal rod, a plastic material, a metal wire net, a synthetic fiber woven fabric or knitted fabric and/or other woven or knitted fabrics and supporting members for installing the same.

16. The method for molding the fiber aggregate according to claim 1, wherein the filling density is regulated so that the filling density of the fiber aggregate which fills the determined cavity site is a prescribed density by pushing the filled fiber aggregate into the divided members of the mold or additionally filling the divided members of the mold with lumps of the fiber aggregate during filling of divided members of the mold with the fiber aggregate.

17. The method for molding the fiber aggregate according to claim 16, wherein the filling density of the fiber aggregate which fills each cavity site of the determined divided members of the mold is regulated so that the filling density of the fiber aggregate which fills each cavity site of the determined divided members of the mold is the prescribed density by blowing compressed air/heated air when the filled fiber aggregate is pushed into the divided members of the mold.

18. The method for molding the fiber aggregate according to claim 1, wherein the filled fiber aggregate is made to hardly slip on a filling wall of the divided members of the mold close to the horizontal surface and the fiber aggregate is made to easily slip on the filling wall of the divided members of the mold close to the vertical surface.

19. The method for molding the fiber aggregate according to claim 9, wherein mold packing is carried out by covering the right design surface mold member and the back design surface mold member with a skin material brought into close contact with the mold before filling of the divided members of the mold with the fiber aggregate; the right design surface mold member and the back design surface mold member are united into one to carry out hot-molding and the skin materials set on the right design surface mold member and the back design surface mold member are mutually bonded with the mold clamped surface.

20. The method for molding the fiber aggregate according to claim 1, wherein the fiber aggregate which fills the cavity is drilled with drilling tools additionally installed in the divided members of the mold when the divided members of the mold are united.

21. The method for molding the fiber aggregate according to claim 20, wherein the molded product prepared by hot-molding the fiber aggregate is drilled simultaneously with the hot-molding by fitting and inserting a male jig into a female jig while maintaining the male jig and the female jig for drilling the molded product in an accurately positioned state in a mold clamped state of the integral mold or the male jig and female jig are mutually oppositely installed and positioned so as to align each center line of the two jigs before clamping of the mold members of the integral mold; hot-molding is carried out in a state of the butted tips of the two drilling jigs and drilling is carried out in the molded product simultaneously with the hot-molding.

22. The method for molding the fiber aggregate according to claim 20, wherein the drilling jigs per se are heated or a heating means is additionally installed in the drilling jigs to melt the fiber aggregate present in the drilled site when the drilling is carried out.

23. The method for molding the fiber aggregate according to claim 1, wherein the divided members of the mold kept in a mold clamped state are integrated in a united state and independently freely movable.

24. The method for molding the fiber aggregate according to claim 23, wherein the integral mold subjected to clamping of the mold members by filling the fiber aggregate, various kinds of assembled components, skin and/or packings or the like is transferred to a heat-treating apparatus and subjected to hot-molding.

25. The method for molding the fiber aggregate according to claim 9, wherein the direction to pass through heated air and/or cooling air is reversed at least once to hot-mold the fiber aggregate when the heated air and/or cooling air are made to pass through the integral mold after clamping of the mold members or the mold in the developed state before claming of the mold members composed of the right design surface mold member and the back design surface mold member before clamping of mold members to heat and/or cool the mold.

26. The method for molding the fiber aggregate according to claim 25, wherein the flow direction of the heated air and/or cooling air made to pass through the mold is fixed in the antigravity direction and the heated air and/or cooling air are made to pass through the fiber aggregate at least once, respectively by changing the vertical direction of the integral or developed mold.

27. The method for molding the fiber aggregate according to claim 26, wherein the flow direction of heated air passed through the integral mold is the antigravity direction and the heated air is made to pass through the interior of the mold in a state of the protruding surface having the protrusions as the undersurface when a molded product having the protrusions is molded.

28. The method for molding the fiber aggregate according to claim 1, wherein the fiber aggregate is scattered or coated with a functional material, or a functional agent when the divided members of the mold are filled with the fiber aggregate and/or the fiber aggregate is united.

29. An apparatus for molding fiber aggregate by filling a cavity of a gas-permeable mold with the fiber aggregate wherein binder fibers having a lower melting point than that of crimped synthetic staple fibers are dispersed and mixed in matrix fibers composed of the crimped synthetic staple fibers, then passing heated air and cooling air through the interior of the mold and hot-molding the fiber aggregate; the apparatus comprising a plurality of divided members of the mold filled with the fiber aggregate in a developed state, uniting the divided members of the mold as a whole or a group from the developed state and forming a united mold.

30. The apparatus for molding the fiber aggregate according to claim 29, wherein auxiliary mold members for closing an opening possessed by the divided members of the mold are installed.

31. The apparatus for molding the fiber aggregate according to claim 29, wherein the apparatus is provided with a filling means for filling the divided members of the mold with the fiber aggregate, a transfer means for making the filling means freely movable to each part of the divided members of the mold and a controlling means for making the transfer means stay at a prescribed position for a prescribed time according to a predetermined program.

32. The apparatus for molding the fiber aggregate according to claim 31, wherein the filling means is composed of a transporting duct for transporting the fiber aggregate formed into small lumps together with a carrier air stream to a prescribed position and a filling nozzle connected to the transporting duct for blowing the fiber aggregate formed into the small lumps in each of the divided members of the mold.

33. The apparatus for molding the fiber aggregate according to claim 32, wherein a branched duct for filling the cavity of the divided members of the mold with various kinds of pneumatically transportable materials is provided on the upstream side of the transporting duct.

34. The apparatus for molding the fiber aggregate according to claim 31, wherein a heated air blowoff means for blowing off heated air and the filling means are installed side by side.

35. The apparatus for molding the fiber aggregate according to claim 31, wherein the controlling means is a controlling means comprising a programmed cavity shape of the divided members of the mold and a programmed transfer passage of the transfer means and controlling the filled state of the fiber aggregate based on the height for filling the divided members of the mold with the fiber aggregate and/or suction differential pressure information about each site of the mold.

36. The apparatus for molding the fiber aggregate according to claim 31, wherein the controlling means is a controlling means for changing the air flow rate in each site of the divided members of the mold and controlling the filled state of the fiber aggregate.

37. The apparatus for molding the fiber aggregate according to claim 31, wherein a blowoff means for a functional agent for blowing off the misty and/or the powdery functional agent is installed with the filling means side by side.

38. The apparatus for molding the fiber aggregate according to claim 29, wherein an auxiliary mold wall for holding the fiber aggregate which fills the divided members of the mold in the cavity during the transfer of the divided members of the mold from the developed state to the united state is provided.

39. The apparatus for molding the fiber aggregate according to claim 38, wherein the auxiliary mold wall serves also as a uniting guide means for guiding the divided members of the mold transferred from the developed state to the united state to the uniting position.

40. The apparatus for molding the fiber aggregate according to claim 29, wherein a mold clamping guide member for making a part of mold wall composing the united mold during clamping of the mold members of the united mold freely movable in the direction of clamping of the mold members.

41. The apparatus for molding the fiber aggregate according to claim 40, wherein the mold clamping guide member is freely detachable.

42. The apparatus for molding the fiber aggregate according to claim 29, wherein suction apparatus for sucking air from the back surfaces of the divided members of the mold are provided.

43. The apparatus for molding the fiber aggregate according to claim 42, wherein the suction apparatus locally freely regulate suction force for each site of the divided members of the mold.

44. The apparatus for molding the fiber aggregate according to claim 42, wherein the suction apparatus are connected through flexible ducts to the divided members of the mold.

45. The apparatus for molding the fiber aggregate according to claim 29, wherein the divided members of the mold are composed of a right design surface mold member and a back design surface mold member and the mold members have a freely foldable and/or a freely bendable structure.

46. The apparatus for molding the fiber aggregate according to claim 45, wherein the fiber aggregate which fills each of the right design surface mold member and the back design surface mold member in the united state is freely compressed to a prescribed bulk density.

47. The apparatus for molding the fiber aggregate according to claim 46, wherein a pushing means for compressing the fiber aggregate and pushing the fiber aggregate and/or an auxiliary filling means for additionally filing lumps of the fiber aggregate or the like in order to form a deep drawing shape in the design surface are provided.

48. The apparatus for molding the fiber aggregate according to claim 47, wherein a compressed air blowoff means for blowing off the compressed air is additionally installed with the pushing means and/or the auxiliary filling means.

49. The apparatus for molding the fiber aggregate according to claim 29, wherein a constant rate feeding means for continuously feeding the fiber aggregate formed into a sliver state or the fiber aggregate formed into the sliver state with a card for forming the opened fiber aggregate into the sliver state to the mold cavity at a constant rate is provided.

50. The apparatus for molding the fiber aggregate according to claim 49, wherein an opening apparatus for opening the fiber aggregate in the sliver state and the filling means for filling the mold cavity with the fiber aggregate opened with the opening apparatus are provided subsequently to the constant rate feeding means.

51. The apparatus for molding the fiber aggregate according to claim 29, wherein the male jig and the female jig mutually oppositely installed are provided and drilling jigs for fitting and inserting the male jig into the female jig in the state of clamping of the mold members in which divided members of the mold are positioned and integrally assembled are installed.

52. The apparatus for molding the fiber aggregate according to claim 29, wherein the drilling jigs having two oppositely provided protrusions so as to mutually butt the tips and superimpose each center line in a state where the divided members of the mold are positioned and integrally assembled are installed.

53. The apparatus for molding the fiber aggregate according to claim 51, wherein a heating means is additionally installed in the drilling jigs.
